(19) United States
(12) Patent Application Publication
(10) Pub. No.: US 2017/0263144 A1
(43) Pub. Date: Sep. 14, 2017

(54) METHODS, SYSTEMS AND USER INTERFACES FOR BEHAVIORAL LEARNING

(71) Applicant: CHANGEBUD PTY LIMITED, BRADDON ACT (AU)

(72) Inventor: CHRIS HORAN, BRADDON ACT (AU)

(21) Appl. No.: 15/310,367

(22) PCT Filed: May 15, 2015
(86) PCT No.: PCT/IB2015/001508

§ 371 Date: Nov. 10, 2016

Related U.S. Application Data
(60) Provisional application No. 61/993,967, filed on May 15, 2014.

(51) Int. Cl. G09B 19/00; G09B 5/06; G09B 7/06; G09B 7/02

(52) U.S. Cl. CPC G09B 19/00; G09B 7/02; G09B 5/065; G09B 7/06

(57) ABSTRACT

Disclosed are methods, systems and user interfaces for provision of behaviour change coaching in an electronic form that provides resilience training, and other types of behavioral learning programs.

### CROSS-REFERENCE TO RELATED APPLICATIONS

This is a U.S. National Stage application of PCT/IB2015/001508, filed May 15, 2015, which claims the benefit of U.S. Provisional Patent Application No. 61/993,967, filed May 15, 2014, which are hereby incorporated by reference in their entirety.

### FIELD OF THE INVENTION

Disclosed herein are methods, systems and user interfaces for provision of behavior learning that can provide resilience training, in some examples, and/or other types of behavioral learning.

### BACKGROUND

Resilience training (or stress management training) in the workplace is often time offered at a point in a person's career/life when they do not actually need it. Therefore, the messages of the workshops can be lost on them.

In order to build new coping skills and habits, participants need to repeatedly practice new behaviors. If participants don't currently need the resilience training skills they are likely to fail to practice the new resilience training skills and will very quickly forget what they have been taught. When they do need the techniques taught in the workshops that they previously attended, they are often in an urgent or even a crisis situation. Most likely, people have difficulty finding the time to find or participate in another workshop. Moreover, by the time a former workshop participant is in need or crisis, they need personalized attention. Therefore, while workshops may be suitable for teaching participants behavioral habits to better cope with stress or other issues, they are not often effective at the right time in many participants' lives. This issue also applies to many other forms of workplace training.

Participants' motivation to apply and generalise resilience training is shaped by their background, including their pre-training expertise and experiences, their personality and their goal orientation. Their background shapes their perceptions of whether the learned resilience skills are useful, and their confidence in their ability to apply and get benefit from the skills. As a universal intervention, resilience training is designed to be offered to all employees in an organisation, including participants with diverse backgrounds and with different levels of motivation for training.

For example, if a participant is currently studying and their background pre-disposes them to experience study anxiety, he or she might perceive the resilience training skills as useful and be more motivated to practice the skills. Alternatively, a participant's motivation to practice the skills might be low if the participant does not find studying stressful or if they already have helpful coping skills. This means that there are inevitably many participants at the start of resilience training who are not motivated to learn new stress management skills.

Another example is law enforcement officers. Due to the nature of the job and the situations they encounter, many officers suffer from workplace stress. Oftentimes, officers are required to participate in mandatory resilience training; however this training may be overlooked or forgotten at times of severe stress. Officers may also undergo mandatory psychological evaluation as part of their job qualification, but as with the classes, such a screening may not occur at the same time as a stressful event. Further hindering the resilience training of officers can be the perceived weakness of admitting undue levels of stress.

If participants remain unmotivated and they do not practise new skills from the training, it is unrealistic to expect changes in their coping and lifestyle behaviours and unrealistic to expect changes in mental health measures following training. This is especially the case for participants who are not stressed at the start of training However, while a participant may not be stressed or motivated to develop new coping skills during the training, this may change later in their career after a stressful event.

A related problem occurs for clients/patients of a mental health provider, counsellor or coach. Many of these clients need to develop more effective coping skills in order to be able to recover from their stressors or they may want to develop new skills to help them achieve a goal. Practitioners foster the development of helpful habits by assigning between-session activities for clients to complete between sessions with the practitioner. Completion of these activities is related to improved outcomes. However, clients often fail to complete these activities, and as a result, outcomes are compromised, such as taking longer to recover, lowered satisfaction with the recovery process, and decreased success rates. In addition, following the completion of treatment/coaching, many clients relapse in the absence of continued support.

Therefore, the art would benefit from improved methods and systems of improving the outcome and success rates of behavioral learning techniques in a manner easily adopted by a range of patients and participants with various backgrounds and stressors.

### SUMMARY OF THE INVENTION

Disclosed are methods, systems and user interfaces for behavior learning. The behavior learning can be resilience training or other behavior training and/or coaching.

In some aspects, the behavior learning methods receive input of at least one event factor value. In response to the received event factor value, the methods also generate one or more activity prescription values based at least in part on the one or more event factor value. The activity prescription value is based at least in part on a strength value. The method also generates an output of one or more suggested activities based on at least one of the one or more event factor values, the activity prescription value(s), and the strength value.

### BRIEF DESCRIPTION OF THE DRAWINGS

FIG. 1 is a diagram of a behavior learning system according to an embodiment of the invention.

FIG. 2 is a block diagram of a behavior learning system according to an embodiment of the invention.

FIGS. 3-25 are various client or user portal screens according to an embodiment of the invention.

FIGS. 26-56 are various practitioner portal screens according to an embodiment of the invention.

FIGS. 57-64 are displays of the User registration and resilience testing according to an embodiment of the invention.

### DETAILED DESCRIPTION OF THE INVENTION

Motivation for people to learn new coping behaviours can be categorised into one of the following “stages of change”:

Pre-contemplation: “I have never thought about how to cope with stress”

Contemplation: “I am actively looking for new ways to deal with stress”

Preparation: “I am currently learning new approaches”

Action: “I am actively using stress management techniques day to day”

Relapse: “I have stopped using helpful coping strategies”

Under this model, users who start training in the pre-contemplation, contemplation and relapse stages have a low motivation to practice the skills. While other forms of training use assessment tasks to ensure that unmotivated participants practise and develop new skills, this strategy is unlikely to be successful for developing new coping behaviours as coping is largely private and not visible to an outsider. A more appropriate approach for an unmotivated participant in resilience training, as recommended by the trans-theoretical model (TTM) of behaviour change, is to tailor their training such that it focuses on increasing the participant's awareness of stress, building their motivation to take action, and making sure they know what they need to do if they want to start building the skills later.

To help users who are members of organizations and/or who are using the services of a therapist/practitioner/clinician to tailor training to their own needs, and to refresh or build their skills as required, it is recommended that a sophisticated performance aid is developed that makes it easy for users to practise the learned skills. To maximise adoption, any performance aid may be introduced during workshops or e-learning or during consultations to ensure that participants are familiar with using it.

Performance aids are tools that help participants to remember key knowledge and practise skills. Performance aids reduce the amount of time required during training as they allow for skills and knowledge to be developed after the training is complete to reinforce the skills learned during the training. They are particularly attractive in a universal intervention for participants in early stages of change, who are not yet ready to apply the skills or with participants who are known to encounter stressors in their personal lives or careers, such a law enforcement personnel and members of the military. They are also attractive in time-constrained work environments where it is difficult for large numbers of employees to take time off from work to attend training. Further, they are attractive as an adjunct to personal and/or career therapy/coaching, by providing a structure for clients to practise skills and track changes in between consultations.

Performance aids can be built using technology such as smartphone Apps. Such technology offers the potential to build a more personalised, feature rich, convenient and private performance aid. The App could also make it easier for training participants to practise new skills immediately following training, or later, if and when they move into an action stage. It also offers opportunities to improve homework compliance between therapy/coaching consultations and for learners to learn at their own pace. Furthermore, military service members and law enforcement personnel have been found to be more likely to access support using technology as opposed to support involving a person, like a therapist or counsellor. The ability for patients to explore mental health issues anonymously and privately could help overcome stigma barriers to the help they are seeking.

A user can register for the behavioral learning system. As part of the registration an initial, simple self-assessment (including protective factors, triggers, symptoms, habits and motivation to change) can be completed by the user. The output from the self-assessment can be used to generate a list of tailored activities that the user can be independently completed to become more resilient (including activities to build motivation if necessary). Tailored activities can be done in private.

The behavior learning system can assist people in managing and coping with stress. The stress can stem from the workplace and workplace related issues a person is experiencing. Often the pressure associated with a job combined with a person's stress from their personal life can lead to chronic stress situations. Chronic stress can take a significant toll on person's mental and physical health. Additionally, chronic stress can economically impact employers or organizations as workers or members who are experiencing high stress become less productive and functional due to the stress. Many workplaces and organizations offer employees and members training in dealing with stress, these can include workshops and personal therapy sessions. While attending these events, workers or members can learn coping strategies and methods, however, outside of these events a small minority of the workers or members are able to practice the techniques and learnings. The behavior learning system assists in correcting this, providing users on-demand training, tools, and techniques for coping, managing and transforming stress and other behaviors.

The disclosed behavior learning integrates into many aspects of a user's life, assisting them in behavior modification and training. Through the behavior system, users are able to document the causes of their behaviors, complete activities to help form habits and achieve goals for improved mental and physical well-being. Done in conjunction with a practitioner's guidance and counselling, users can habitualize healthy learnings and techniques to improve their lives.

The methods, systems and user interfaces of the present invention provide several layers that interact with each other to ultimately provide resilience building and/or other behavioural learning programs to end users. While the present description is mostly directed to the resilience building, there are other applications for the same structure. For example, the methods, systems and user interfaces can be useful for helping end users with other potential behaviour changes, e.g. addictions, pain management, crisis management, leadership skills development, sales skills development, physical therapy recovery, weight loss and/or diet changes, personal training and the like.

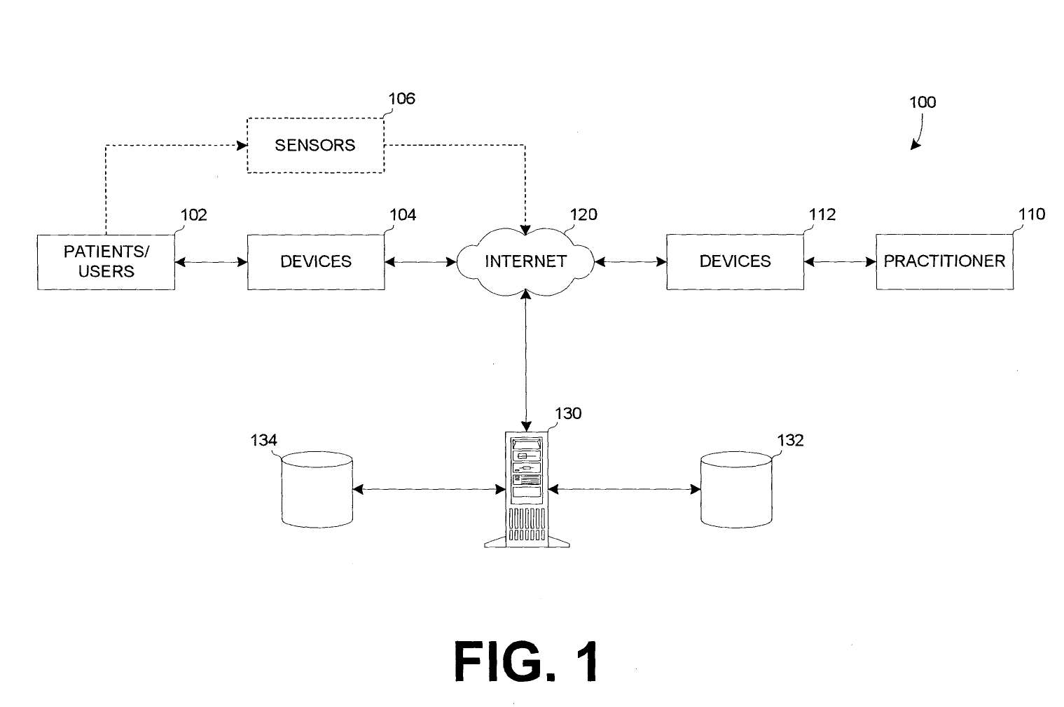

FIG. 1 is a block diagram of the behavior learning system 100 according to an embodiment of the invention. Patients and/or users 102 use devices 104 to transmit data through the internet 120 within the system 100. Devices 104 can include computers or smart phones. Additionally, optional sensors 106 can be used by users 102. The sensor 106 data can be transmitted within the system 100 and used by practitioners 110 and the system 100 to recommend learning techniques. Practitioners 110 can use devices 112, similar to the user devices 104, to communicate with and within the system 100.

A server 130 contains the system 100 programming and distributed information amongst the databases, the users and practitioners.

The example embodiment of the system 100 as shown in FIG. 1 can include a patient information database 132 and a content database 134. The two databases 132 and 134 can exist as separate databases or on the same server 130.

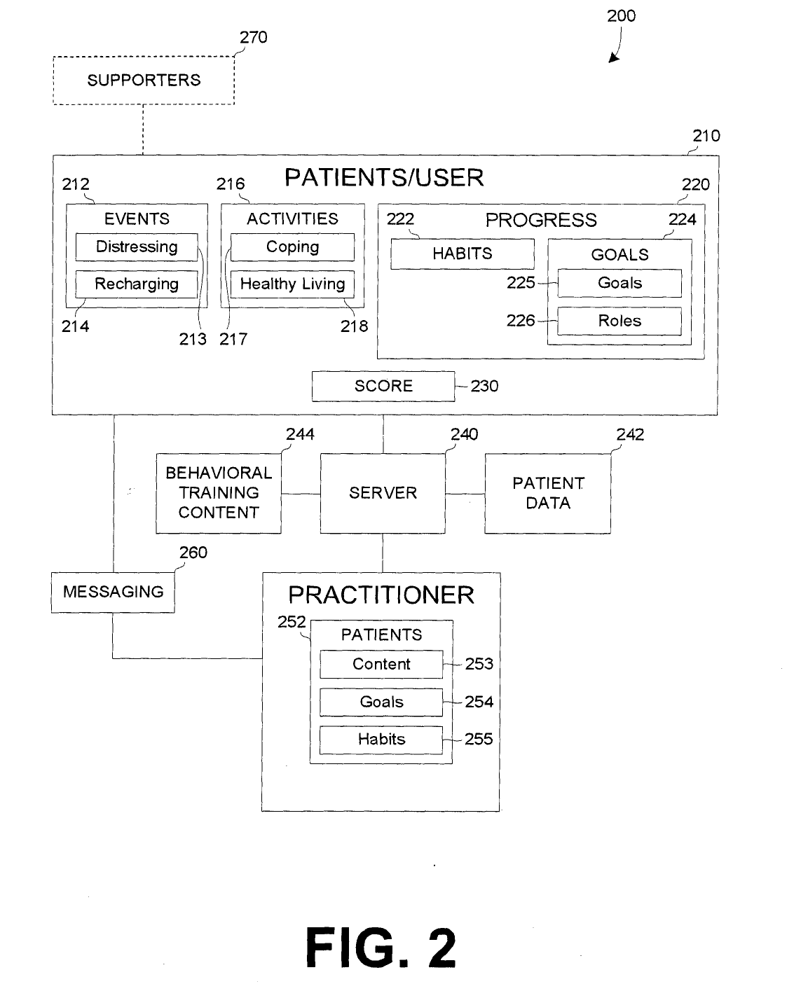

FIG. 2 is a block diagram of the behavior learning system 200 according to an embodiment of the invention.

The patient/user portion 210 of the behavior learning system 200 includes events 212, activities 216 and progress 220.

The events 212 experienced by the user are categorized as distressing 213 or recharging 214. Distressing events 213 are events that cause a user to experience stress or other negative feelings. A distressing event 213 can be considered a stress factor, stress factors are a class of event factor. Stress factors can include stress triggers, stress symptoms and coping responses, which comprise the trigger, impact and behavior of the stress factor class event factor. Recharging events 214 are events that cause a user to experience good feelings. Events 212 are logged by the user and recorded within the system 200. Practitioners can view and assess user logged events. Additionally, the system 200 can score or quantify user logged events. The score of the logged event can be used by the system 200 to provide the user customized behavior learning techniques and activities.

Users can complete or explore activities 216. The activities 216 can be divided into two categories, coping activities 217 and healthy living activities 218. Activities 216 available to a user can be preselected by a practitioner for the user to complete. Coping activities 217 are designed to teach a user skills to assist them in coping with difficult situations the user encounters. Healthy living activities 218 assist a user in maintaining a behaviourally healthy lifestyle. The activities 216 available to a user can be selected from a list of suggested activities.

In the embodiment shown, a user's progress is monitored by the user's habits 222 and goals 224. A user completes the activities 216 to assist behavioral learning, the learned behaviors transition into habits 222. The habits 222 assist the user in reaching goals 224, which are defined as a goal 225 and roles 226. The roles 226 are the aspects of a user's life the goal 225 effects.

A user can be assigned a score 230 by the behavior learning system 200. The score 230 quantifies the user's progress in the system and can be used for a reward system.

A user communicates with a server 240 of the behavioral learning system 200. The server 240 receives information and input from the user 210 and the practitioner 250. The server 240 assists the user 210 in achieving their goals and behavior learning. Additionally, the server can adapt the user's 210 activities, or suggested activities, based on a user's input into the behavioral learning system 200.

Users' data, including the user inputted data, of the system 200 can be stored in a database 242 that communicates with the server 240.

Behavioral training content can be stored in a database 244 that communicates with the server 240. System administrators and/or practitioners can add and/or edit content of the database 244.

Practitioners 250 can monitor and manage the user's 252 content 253, goals 254 and habits 256. The practitioners can select content 253 that the user 252 has access to. In this way, the practitioner can manage the flow of content 253 to the user 252 to prevent the user from being overwhelmed. Also, by managing the content 253, the user can use the behavior learning system 300 as a supplement to the practitioner provided in-person/personal therapy sessions.

The user 252 managed by the practitioner 250 can be a single user of a group of users who have similar goals or can be users from a single workplace or organization.

Practitioners 250 can invite 256 users to the behavior learning system 200. Each invited user creates their own profile and their user data is stored securely from the other user's data and from outside intrusion.

The practitioner 252 and the user 210 can communicate using an internal messaging service 260 within the behavior learning system 200. Using the messaging service 260 the practitioner can assign and send exercises, such as questionnaires, to a user or user group. Users can use the messaging service 260 to communicate with the practitioners.

A user 210 can optionally have supporters 270 that form a support network for the user's work within the behavior learning system 200. Supporters 270 can include family members, friends, acquaintances and other behavior learning system users 210. The supporters 270 can see a user's 210 progress and provide feedback and encouragement to the user 210.

A method for resilience building can include receiving input of at least one event factor value. An event factor value can be defined as triggers, symptoms (or impacts) and behaviors and any other parameters that are relevant to the particular use associated with this invention. The proprietary collection of event factors is relevant because these factors represent a distinct taxonomy including all possible factors relevant to stress, which can be efficiently used to generate personalised suggestions that may reduce the impact of stress. By providing as a result of the received event factor value, at least one activity prescription value characterized by a strength value, and generating an output of one or more suggested activities, a user may consider the suggested activity. Strengths, or strength ratings are indications of the potential benefit than an activity may bring in addressing an event factor, relative to other activities. Suggested activities are ordered according to the strength ratings of prescribed activity values and might be based on patient parameters, in some examples. However, what the user sees is an order of suggested activities based upon cumulative prescription strength values for an event factor ticked in their user interface.

An event factor value can have a plurality of activity prescription values associated therewith. Defining the event factor with a plurality of activity prescription values is possible. There may be different weighting variables associated with an event factor.

An event factor is a component that forms part of the response or feelings experienced by a user during a distressing, recharging or other event. In the example behavior learning system shown in FIGS. 1 and 2, event factors can include items that triggered the event, behaviors the user exhibited during the event and the impacts felt by the user from the event. The behavior learning system is prepopulated with selected event factors, however, practitioners and/or users can add additional event factors as they find necessary.

In another embodiment, a plurality of event factor values can be received and a method can include providing as a result of the received plurality of event factor values, a plurality of activity prescription values and generating ordered suggested activities output.

One way in carrying out a method of the invention is for each event factor that is identified by a user in their resilience check (e.g. ‘Thoughts of failure’/‘Conflict with colleagues’), an algorithm checks the activity prescriptions values for that event factor and suggests each with the strength described by the prescription.

If it so happens that the same activity is suggested for more than one event factor, then the strength assigned to that suggested activity is the combined strength of those prescriptions (For example, ‘Thoughts of failure’ and ‘Conflict with colleagues’ are event factors that could be prescribed ‘Be kind to yourself’ with a strength of 5 and 6 respectively, then the suggested activity ‘Be kind to yourself’ will have a strength of 11). The suggested activities are then displayed in the order of strength.

Practitioners, or the behavior learning system, can also add event factors that are not selected by a user for other factors, such as low sleep when the user's sleep is less than 7 hours, and high sleep when it is greater than 10 hours.

A method of the invention can also provide when there is more than one suggested activity provided, the suggested activities can be provided in an order over time. In this way there may be a progression of suggested activities provided.

A method of the invention can include transmitting at least one suggested activity to be delivered via an application to a mobile device.

An event factor value may be weighted according to a predetermined parameter. For example, an event factor value may be weighted by goal input values, received intensity values and/or received control values. Different attributes such as control can have degrees such as low, medium and high. For example, when a user is angry or in conflict with colleagues, they may be able to weight their temper as low, medium or high. Other attributes are within the scope of this invention. Weighting can be provided in any and all values described herein.

Event factors can be provided to the system in any suitable manner A mobile application can receive input of event factors provided by a user. Moreover, an event factor value can be provided via electronic detection means, that is by sensors associated with a user, such as one that a user might wear to detect pulse rate, temperature, muscle contractions and the like. The suggested activity can be provided as output in response to the electronic detection of the event factor value, for example, in real-time. While a mobile device including a mobile application is one manner in which a suggested activity can be presented to a user, there are many others contemplated. For example, certain worn devices, such as glasses are capable of receiving input and may be able to communicate to a user a suggested activity. Suggested activities could also be relayed via a supporter such as a health professional or coach. Other worn devices, for example as a watch, may carry out an action, such as a chime, or a vibration, that could be used to remind a user to carry out a suggested activity, such as concentrating on breathing, or other relaxation techniques.

Depending upon the use of described methods and systems, event factors, activity prescription values, suggested activities, habits, goals and/or any other input value associated therewith such as strengths and weighting can be predetermined as part of a system, or can be customizable so that the system can be used in a multitude of behavioural learning applications.

Other features of the systems and methods can include time and location stamping event factor input. This feature may be valuable for assisting users, therapists and coaches to identify patterns, which can then be used to influence the order, both in terms of likely helpfulness and in terms of time, of suggested activities. For example it may reveal to users therapists and coaches that certain times and locations are likely to trigger greater levels of stress or less productivity, or trigger unhelpful habits, leading to activity suggestions that reduce unnecessary negative impacts.

A method and system for resilience training may also include receiving an event factor value input, receiving a goal value input, correlating the event factor value with the goal value to generate a correlated value, and generating an activity prescription value corresponding to the correlated value, and generating output indicative of a suggested activity. Correlating goals to event factors is a way to generate a suggested activity since activities that are associated with personally meaningful goals (aligned with personal values) for a user are known to bring improvements in mental health. Goals can be aligned with personal values in a plurality of domains. By domains it is meant categories of goals such as areas of life (e.g. self-development including physical, cognitive, emotional and spiritual aspects of self, relationships, work and education). Personal values can be characterized by intrinsic motivators, characteristics that in and of themselves, are personally inspiring, meaningful and motivating for an individual, that can be used to direct users towards setting meaningful goals.

In another aspect of the present invention a method and system for resilience training can include receiving an event factor value as input, correlating to the event factor value a suggested activity, generating as output a suggested activity, wherein the suggested activity provides habit values, wherein the habit values can be personalised by a user. In another aspect of the invention, a habit value is associated with a response field which when populated provides a habit tracking value. Habit tracking values in the response field which are received as input can provide an ability for the system to determine whether the user is carrying out suggested activities. Time for developing habits can be pushed to the user interface of the mobile application, for example. Developing habits may be prompted daily, or more frequently or less frequently. Tracking the habit gives the user an opportunity to say “yes, I did it”. Habit tracking values can be input either by the user, a supporter such as a therapist, or they could be detected automatically by electronic means. For example, if running was a habit value for a user, then a mobile application could be used to detect when the user has been running and populate the habit tracking value and a goal tracking value.

Progress of the user may be determined by the habit tracking values and goal tracking values and measured as a score. These tracking values may be utilized to initiate social reinforcement and may provide the ability to generate success reports. This may be particularly useful for organizations where certain segments of the organization experience specific types of similar event factors. Further customization of the variables of the described methods and systems may be result of success reports, habit tracking values, for example, kudos, comparatively, directly from social contacts, that is, people that matter, directly from organizational contacts, and/or directly from professional contacts.

As mentioned above, event factors may be representative of triggers, symptoms and unhelpful habits. Event factors provide prepopulated, genericized elements that users and practitioners can use to communicate aspects about an event. The aspects can include what triggered the event, the impact the event had on the user, including what they experienced during the event, and behaviors exhibited by the user during the event. These factors provide a common frame work that the user and practitioner can use to discuss the event and gauge and track progress of the user on accomplishing the established goals. While these event factors are described herein, there may be others defined as well, and/or other variable may be used in conjunction with the event factors. Also as mentioned above, electronic detection means may be utilized to determine event factor input to the systems, and utilized by the methods.

Another aspect of the systems, methods and user interfaces of the present invention is e-learning including presenting content modules relating to event factor values representative of triggers, impacts and behaviors, correlating the content modules to a mobile application having attributes, wherein at least some of the attributes are demonstrated in the content modules and providing exercises within the modules configured to teach the use of the mobile application. The e-learning is general behavior, mental and physical health knowledge a user and/or a practitioner can access and interact with. In the example behavior learning system described herein, the e-learning refers to educational portions of the system. User can read about various mental health and behavior topics to further their knowledge. Users can find this useful in further explaining their condition and/or behavior.

The behavior learning system can also provide a dedicated e-learning module that users can complete. A dedicated module can be used by employers and/or organization to provide stress and behavior management training to employees and/or members. The content modules of the e-learning embodiment can be learning sections, with each content module focused on a specific aspect of mental and behavioral health. Attributes of the mobile application can include the functioning and look of the mobile application. An e-learning content module(s) can be dedicated to teaching a user how to use the mobile application. Providing a tracking system of the exercises to determine that the exercises have been processed may also be included. Excerpts of the e-learning content is also available in the mobile application to refresh the knowledge of users who have already completed the e-learning.

The e-learning module can be an interactive content module that a user or users can complete. A practitioner, organization or other can oversee the administration of the e-learning module. The e-learning module can substitute for class time, allowing users to complete requisite lessons at their convenience or on a schedule as set by an e-learning administrator. Data collected from a user of the e-learning module can be used to pre-populate data in the user's personal client profile within the behavior learning system. Additionally, the data collected from the users of the e-learning module can be aggregated to provide an overall view of the user group. This data can be aggregated as desired during or after the e-learning module, in this way progress of the user group, both behaviorally and through the e-learning module, can be tracked.

Another aspect of an e-learning application is receiving input while a user is utilizing an e-learning application which is transmitted to a back-end system. At the back-end system, a mobile application using the same input can be populated with relevant values of the input so that when a user uses the mobile application, various parameters are populated where that input was received via the e-learning application. In the present example, systems can receive an event factor value input via an e-learning application and methods can include populating a back-end of a mobile application with the stress value received via the e-learning application, providing a suggested activity corresponding to the event factor value, and transmitting suggested activity output configured to be delivered via a mobile application to a mobile device.

In another aspect of the present invention, a method and system for treatment can include receiving input of a plurality of event factor values wherein the event factor values may be selected from triggers, impacts and behaviors, via electronic means wherein the electronic means are associated with a mobile application and providing at least one suggested activity based upon the received event factor values. The suggested activity can be delivered electronically or otherwise, such as interpersonally. Event factor values can be time stamped, location stamped, customizable and/or predetermined. Activity prescription values can be customizable and/or predetermined. Suggested activities can be automated, provided for manual selection and/or can be ordered over time.

As mentioned, the system can have a user interface for a mobile application and for an administrator. A user interface can include, for example, a first screen of selectable icons representing event factors characterized as triggers, impacts and behaviors, means for selecting one of icons, upon selection of one of the icons, a second screen of a list of predetermined event factors can be presented and selected and whereupon selection from the second screen, the selected predetermined event factors can populate the first screen. Input icons can be provided for healthy living parameters. Healthy living parameters can include sleep, diet, relationships, planning and exercise data. These healthy living parameters refer to lifestyle behaviours that increase the capacity of a user to cope with stress. For example, if a user is not sleeping, or they have a poor diet, or poor social support they are more vulnerable to stress related problems.

The user interface can include three lists of activities, including suggested activities based upon event factors, a list of coping activities and a list of healthy living activities. Upon selecting an activity from these lists, the user is presented with an activity interface comprising information about the activity, including the event factors for which the activity is prescribed and media related to the activity, including resources to help the user practise the activity. A user can select a suggested activity or any other activity and that activity may be transferred to the habit user interface. A practitioner may likewise suggest a habit.

The user interface may also include an inbox for receiving distributed messages from organizations, practitioners, personalized messages, and among other types of messages, messages based on the particular user's data such as event factors and their habit and goal progress. Messages can include links, which can direct a user to a questionnaire for them to complete. An icon for resilience tips can initially lead a user to a screen for selecting event factors which ultimately provides the list of suggested activities and other activities as mentioned.

Upon selecting from one of the suggested activities, coping activities and/or healthy living activities, they may be converted into habit values. As mentioned, habit values can be trackable and notifications related to the habit values can be received via the user interface. Habit values can be delivered and explored by the user as content related to the habit, and they may include what, when and why. The user may provide or edit the what, when and why. What is populated with the name of the activity which is editable. The when may have options provided. The why is populated with the reason for the prescription.

Trackable habit values, or any other trackable data, such as goals or event factors input by the user can provide opportunities for data mining and provide revealing insights, for example, with respect to issues faced by people within organizations. In this way, organizations may be able to deal with issues of the organizations through campaign building. Event factors may further be customized for different roles within an organization.

The present invention provides the opportunity for tiered care, that is, where the intensity and number of event factors is low, the automated system may be sufficient. However, where the intensity and number of event factors is high, professional intervention may be provided with a higher level of care as it may be more appropriate. When the intensity and number of event factors is higher, a practitioner may get alerts. Moreover, when the intensity and number of event factors is high the user via the user interface may receive a pushed alert in the automated mode or otherwise to seek professional help immediately or emergency support, i.e. 911, or the like. As the event factors diminish in intensity, again an automated system may be appropriate.

A user interface for practitioners provides the ability to practitioners to invite clients to use the system. This interface also allows practitioners to assign habits and goals for clients to work on with reminders, request clients to complete assessments, and to monitor client data—including event factors, habit tracking, goals, values, supporters, assessments and general activity in the system. This interface also allows practitioners to send and receive client messages via the client's inbox, and to generate client reports, which may be required by third parties such as insurers, employers or medical doctors.

As mentioned above, suggested activities can be associated with goal values which may be input provided by the user via the mobile application and/or an e-learning application. As mentioned, data input in an e-learning application may provide data to a back-end system which can populate a mobile application, and visa-versa.

The back-end system, or the front-end system, including the administration interface, provides fields for content management. A separate content management field may be in communication with the administration interface. In this way, the systems and user interfaces can be customized for different types of organizations and/or different types of practitioners. Variables can be customized. Notifications of any type may be received via the user interface of the mobile application and an e-learning application. The event factors and/or activities may be designed by an organization utilizing the methods, systems and user interfaces described, or may be designed by individual users, such as practitioners.

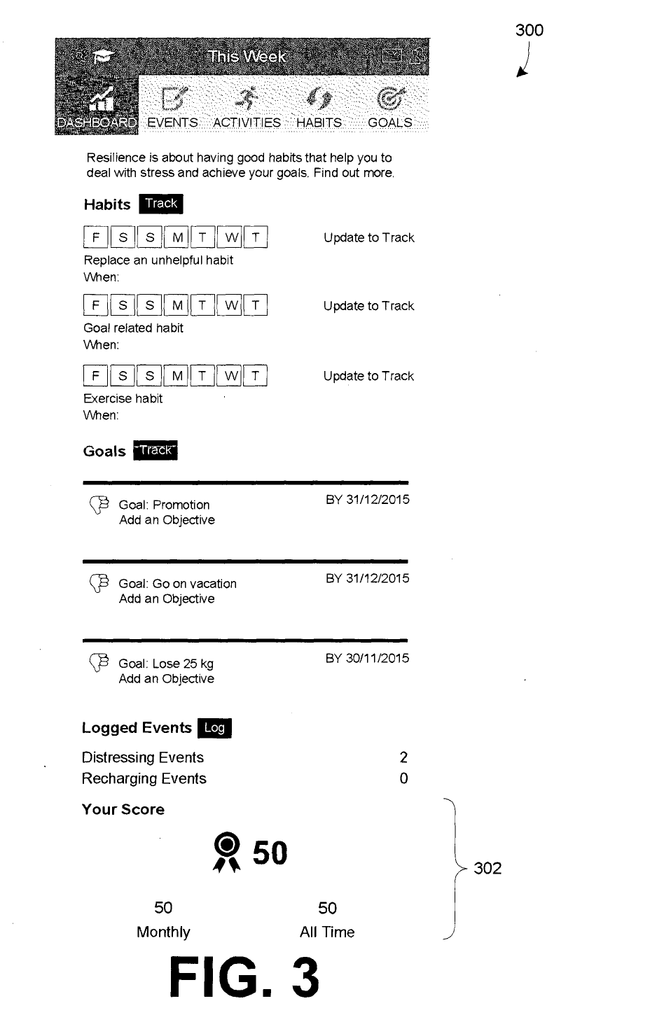

FIG. 3 is an example dashboard screen 300 a User may encounter after logging into the behavior learning system. The dashboard screen allows the User to quickly see their progress through the behavior learning system. A score 302 is shown on the dashboard screen 300. The score 302 can be assigned to the User to quantify and reward the User's progress through the behavior learning system.

In a group of users, progress can be encouraged as a competitive activity. The addition of a competition element can stimulate users to remain engaged with the program. Additionally, users can be rewarded for their progress. For example, if the users are part of an organizational group, the organization can offer the user prizes based on the user's score within the behavior learning system.

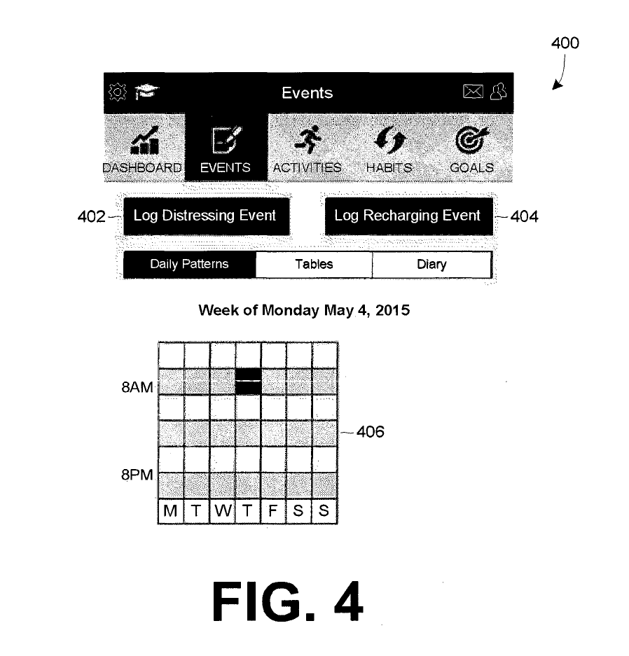

FIG. 4 is an example events screen 400 the User may encounter when selecting the events tab. In the events screen 400 the User can log events and view a timeline of past events. The user can log an event as a distressing event 402 or a recharging event 404. Additionally, the user is provided a visual log 406 of events for the past week.

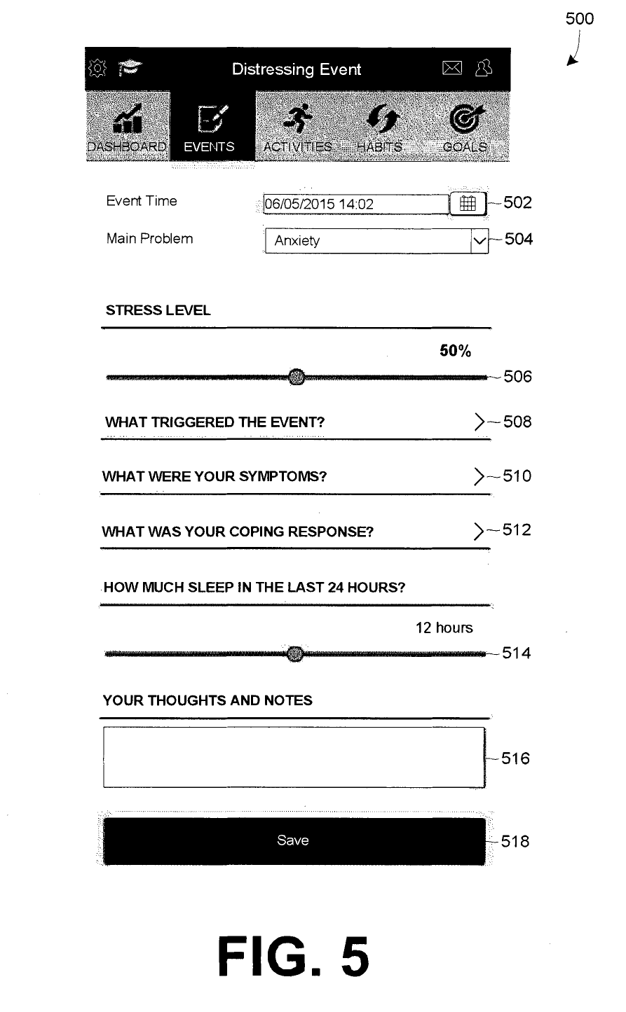

If the user categorizes an event as distressing, they can be redirected to the example distressing event logging screen 500 as shown in FIG. 5. On this screen the user can enter pertinent information regarding the distressing event, including the event time 502, the distress 504, the stress level experienced 506, the event trigger 508, the symptoms experienced by the user 510, the coping strategy used 512, the user's amount of sleep 514 and any additional notes or information 516. The entered information is then saved 518 and an event is generated within and associated with the user of the behavioral learning system.

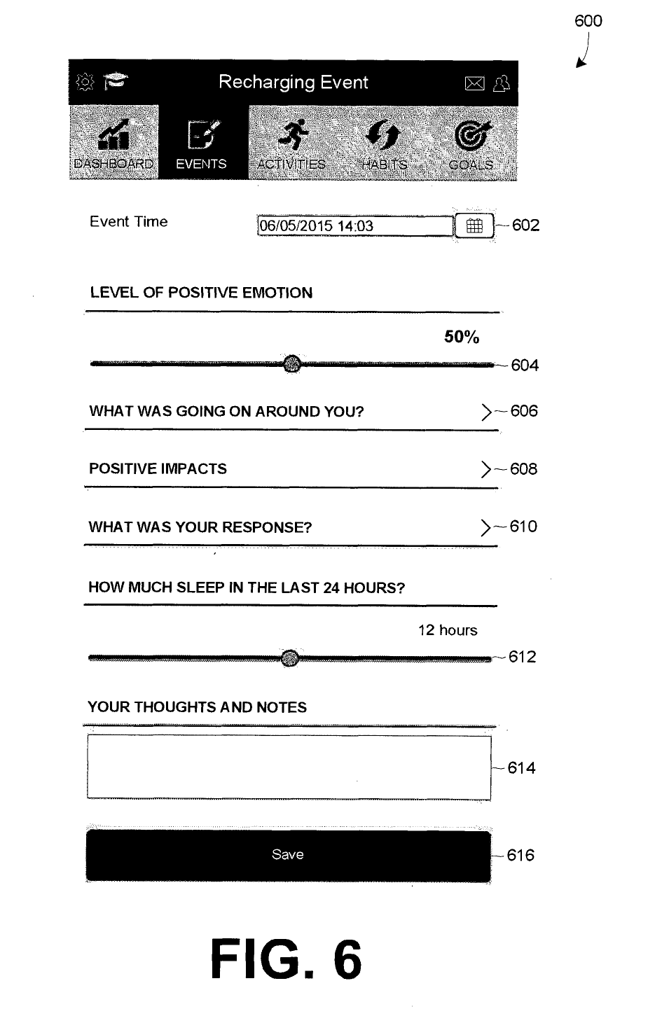

If the user categorizes an event as recharging, they can be redirected to the example recharging event logging screen 600 as shown in FIG. 6. On this screen the user can enter pertinent information regarding the recharging or positive event, including the event time 602, the level of positive emotion from the event 604, what was happening around the user during the event 606, the positive impacts associated with the event 608, the user's response to the event 610, the user's amount of sleep 612 and any additional notes or information 614. The entered information is then saved 616 and an event is generated within and associated with the user of the behavioral learning system.

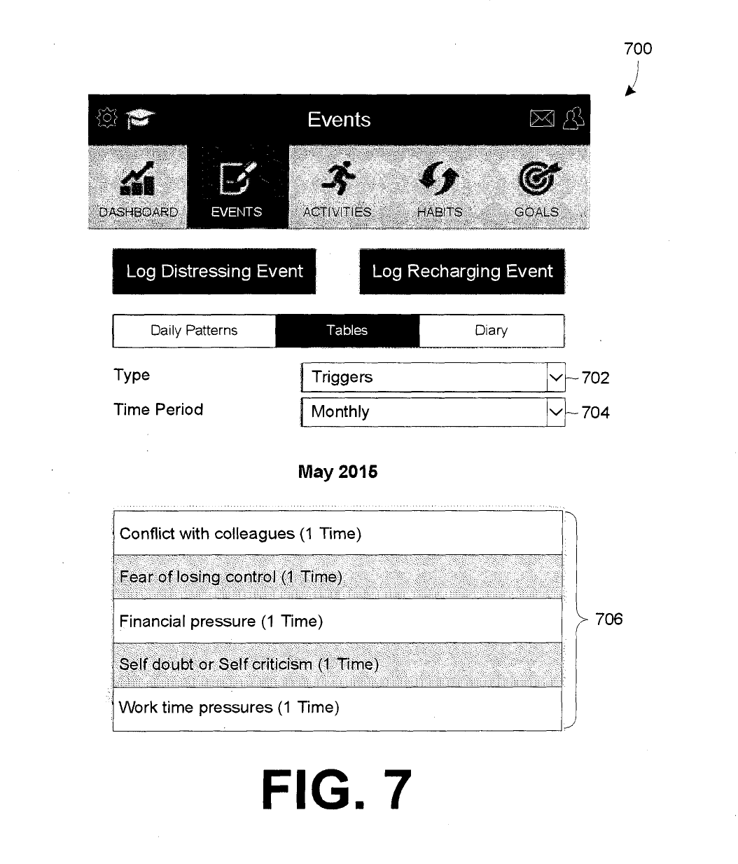

FIG. 7 is a table view 700 of event factors the user has logged. The type of event factor 702 can be selected in the dropdown menu and a time period 704 can also be selected. The logged event factors of the type selected are then displayed 706, the displayed event factors shown for the selected time period. In the example shown, “trigger” event factors are shown in a “monthly” view, that is, the “trigger” event factors logged for May 2015 are shown in order of frequency. The user can then navigate to proceeding or preceding months to view other types of event factors logged including impacts and behaviors.

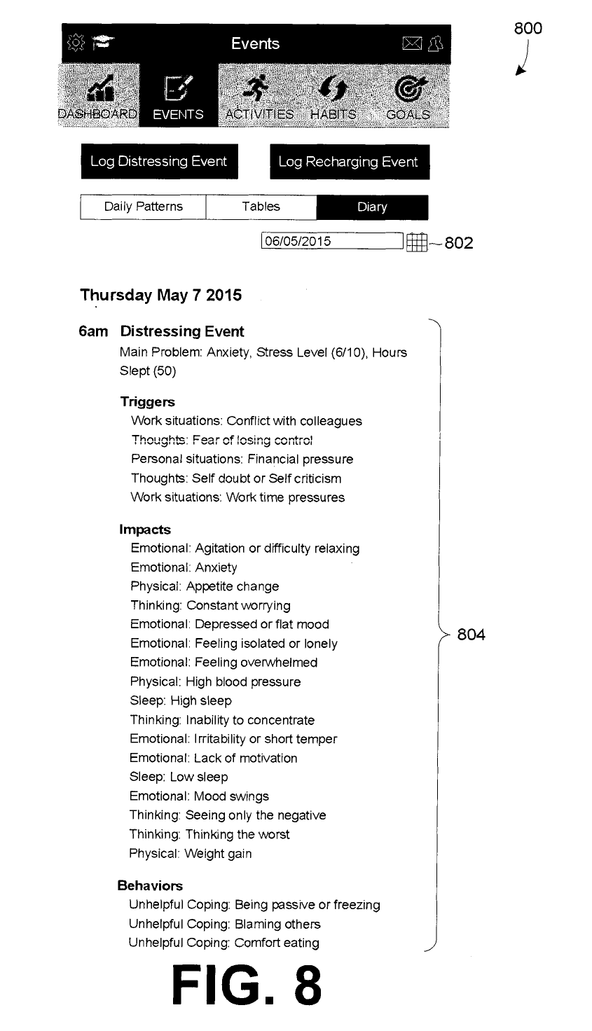

FIG. 8 is a diary view 800 detailing the logged events 804 occurring during a selected time duration 802. In the example shown, the information 804 from a logged distressing event is shown. The distressing event is listed, along with the stress level and sleep amount as entered by the user. The triggers, impacts and behaviors listed are those selected by the user at the time the event was logged.

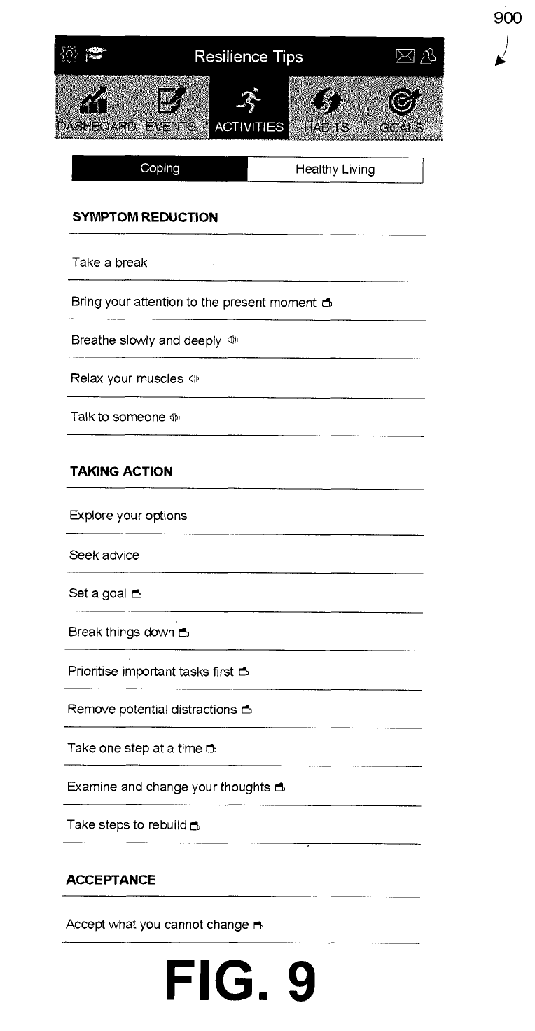

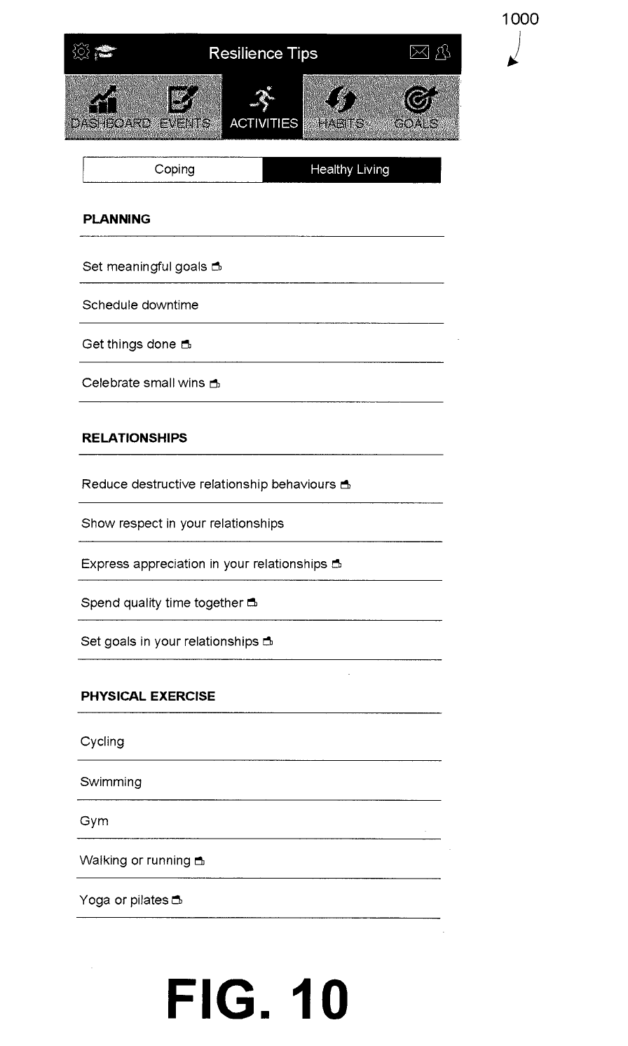

FIG. 9 is an example display of activities associated with coping 900. The example activities listed are ones a user can complete to learn methods and strategies for coping. Some of the activities can include exercises for the user to complete, videos to watch, audio to listen to and/or material to read.

FIG. 10 is an example display of activities associated with healthy living 1000. The example activities listed are ones a user can complete to learn methods and strategies for healthy living. Some of the activities can include exercises for the user to complete, videos to watch, audio to listen to and/or material to read.

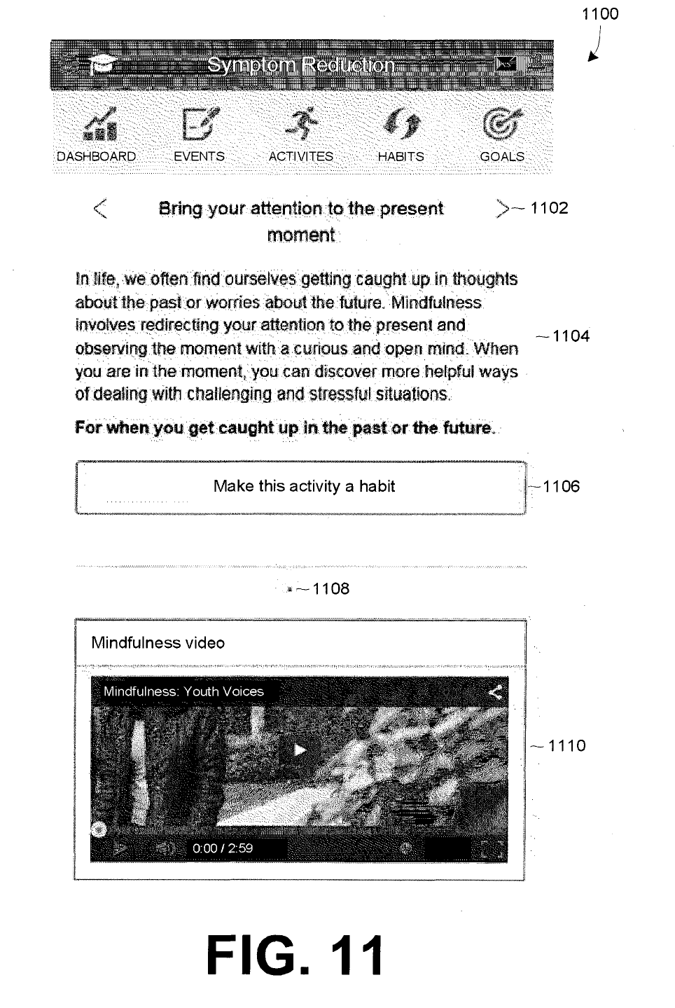

FIG. 11 is an example selected activity 1100. The activity is shown in a heading 1102 and the surrounding activities can be navigated to using the provided arrows. A description and benefit(s) of the activity 1104 are listed and described. The content or exercise of the activity 1110 is shown and can be viewed or completed by the user. If multiple pieced of content or exercises are provided for an activity, an indicator 1108 can display to the user which piece of content they are viewing. Additionally, a user can select to make the selected activity a habit 1106.

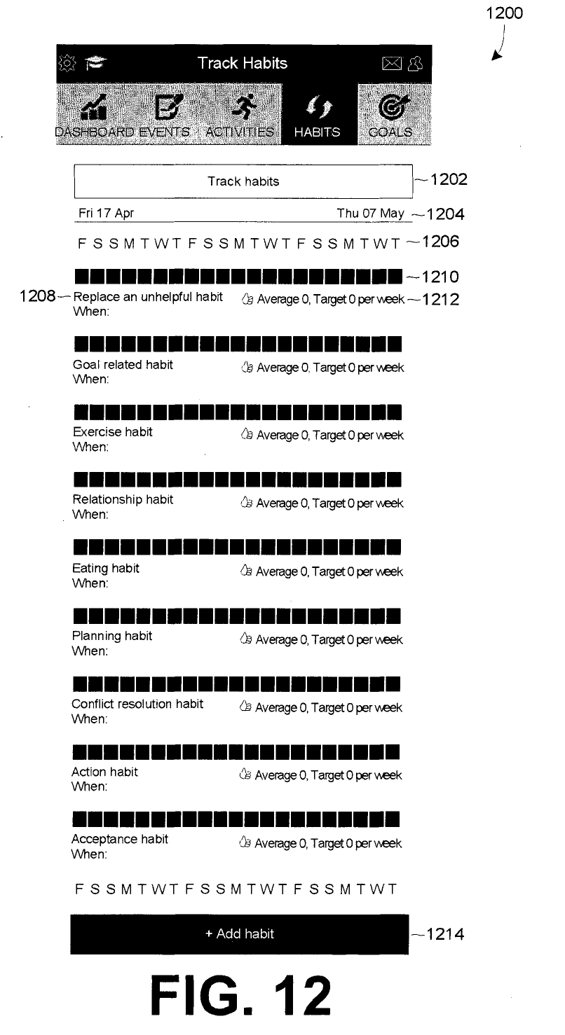

An example display of the overview of the habits tab 1200 is shown in FIG. 12. From this screen, the user can see a list of habits, which can be tracked 1202. An example habit 1208 is shown and includes an indication bar 1210 and a counter 1212. The indication bar 1210 is correlated to the days 1206 of the time range 1204, and indicated on what days during the time range a habit was tracked. The counter 1212 can indicate the number of times a habit was tracked and a target amount of habit tracking the user should achieve. Additional habits can be added 1214, allowing the user to track multiple habits as needed or desired.

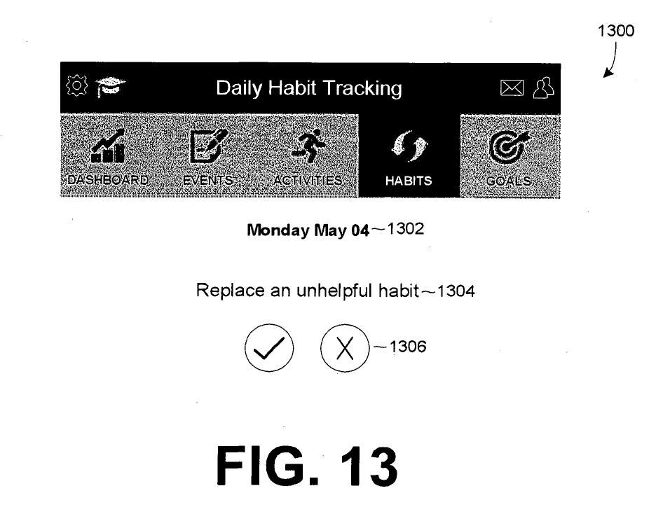

FIG. 13 is an example display of a tracking habit input 1300. A habit 1304 can be tracked with 1306 with a simple yes/no or other suitable assessment input means. A timestamp 1302 is associated with the tracked habit 1304.

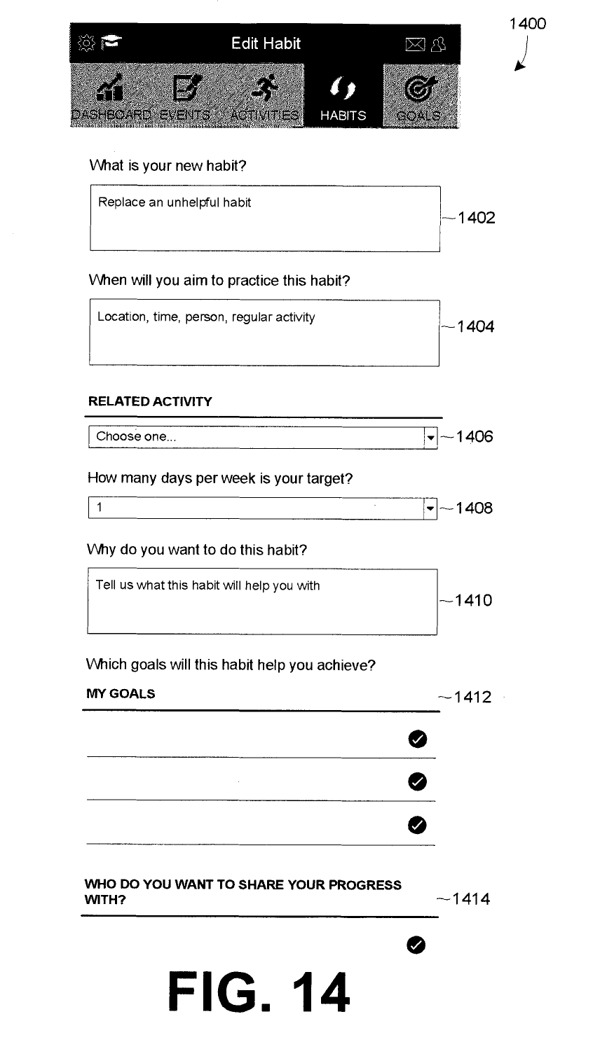

A user can enter a new habit using the example habit input screen 1400 of FIG. 14. In this screen, the user can input the new habit 1402, how the habit will be implemented 1404, select an activity 1406 associated with the habit, a target number of times 1408 to implement the habit, a record 1410 of how the user believes the adoption of the habit will help, the goals 1412 the habit will help the user achieve and a list of supporters 1414 to share the progress of the habit with.

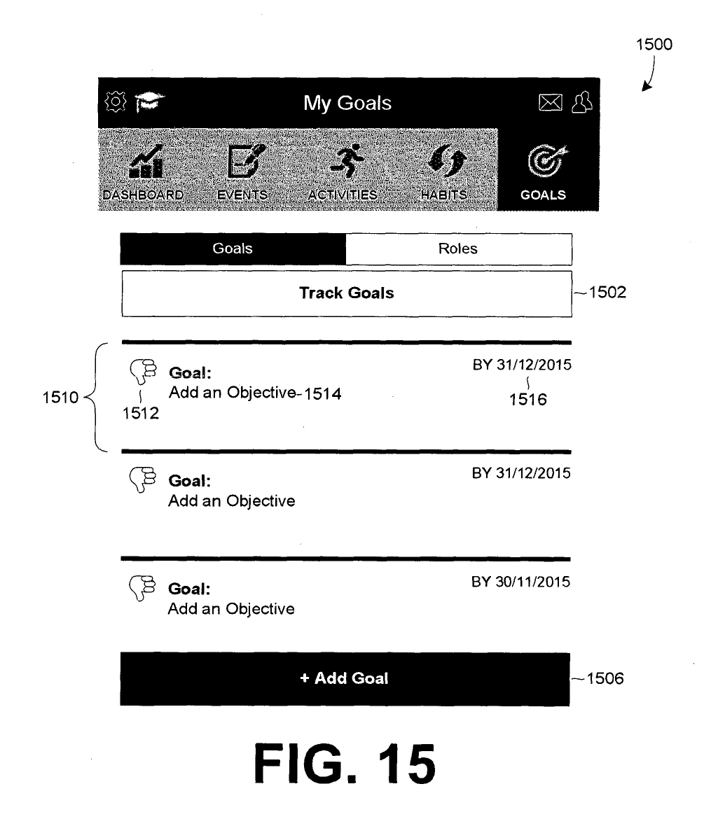

An example overview display of a user's goals 1500 is shown in FIG. 15. A listing of the user's goals 1504 is shown and the user can select to track goals 1502 and/or add a goal 1506. A goal 1510 includes an indicator on goal progress 1512, a list of objectives 1514 and a goal deadline 1516.

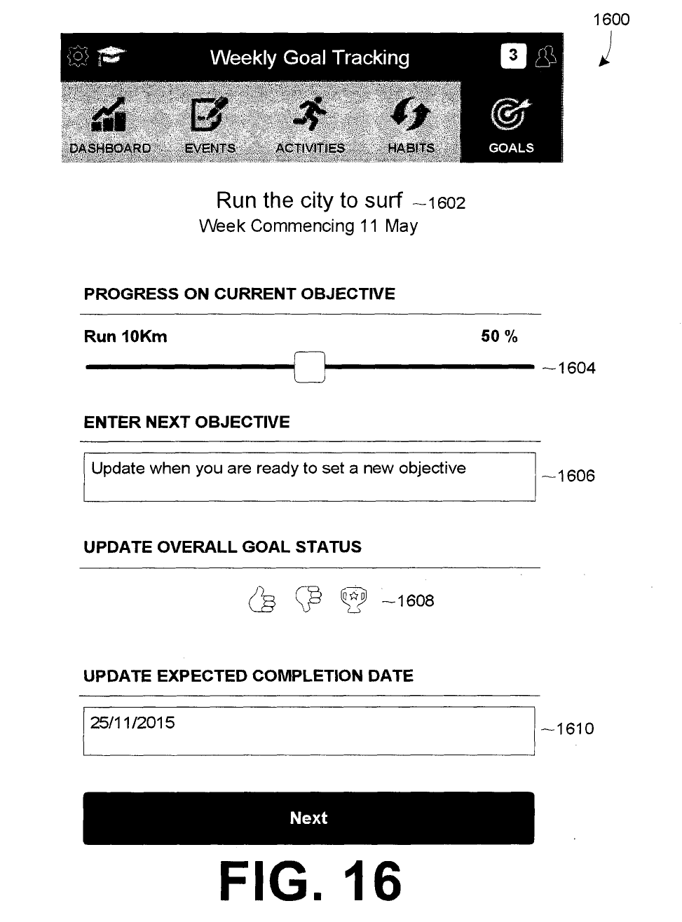

An example goal tracking screen 1600 is shown in FIG. 16. The user is shown the tracked goal 1602, the progress of which they can indicate 1604. Users can also enter the next objective 1606 for the process of accomplishing the goal 1602. A goal status 1608 can be updated by the user. The goal status can then be seen by the user's supporters. The goal status 1608 can also be determined by the behavior learning system based on the indicated progress 1604, the current date and the expected goal completion date 1610. The user can edit the goal completion date 1610.

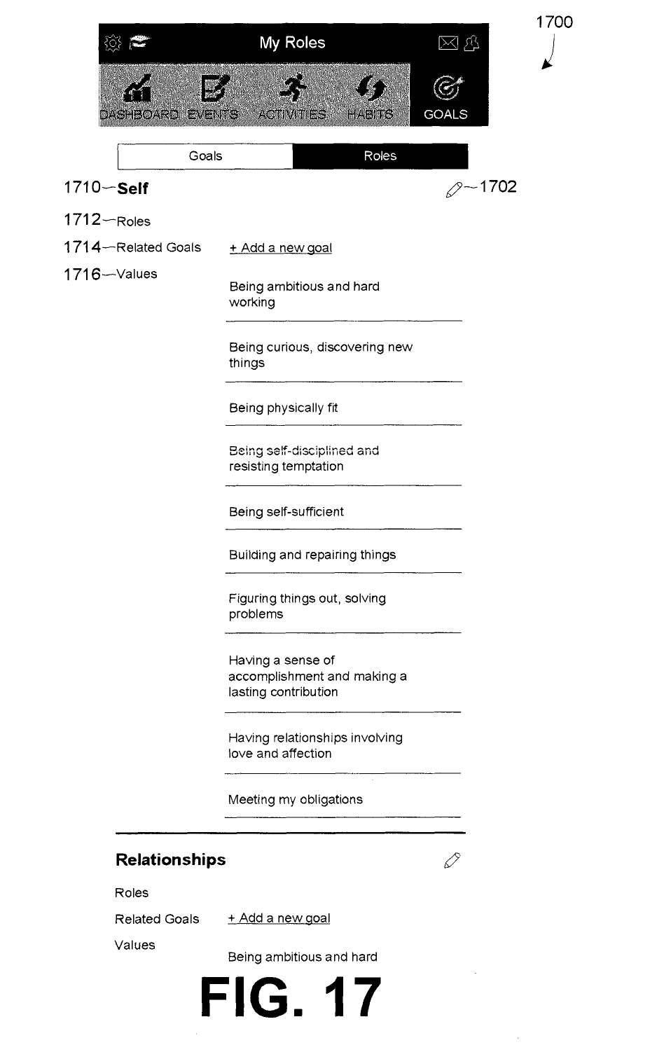

A user may have various roles in different aspects of their life. The user's roles can impact the user's goals and achievements of them. A user can enter or select their roles for various aspects of their life within the behavior learning system. For example, in a relationship aspect of their life, the user could input “good spouse or significant other.” In doing so the user is acknowledging that the listed role is important to an aspect of their life. When setting a goal, a user can consider the roles they have entered or selected, to ensure there is not a conflict between a role and the potential goal. The roles also assist a user approach goals in a more rounded manner to assist in achieving and maintaining a life balance. By maintaining a life balance, a user is not overly focused on a single aspect of their life, rather they see and consider the various aspects of their life and maintain a balance between them. Maintaining the life balance can help a user achieve better overall behavioral health. A user's life aspects, and the roles associated, are shown in the example roles display 1700 in FIG. 17. The life aspect 1710 and associated roles 1712 is displayed, along with goals 1714 and values 1716 associated. The elements of the aspect 1710 can be edited 1702.

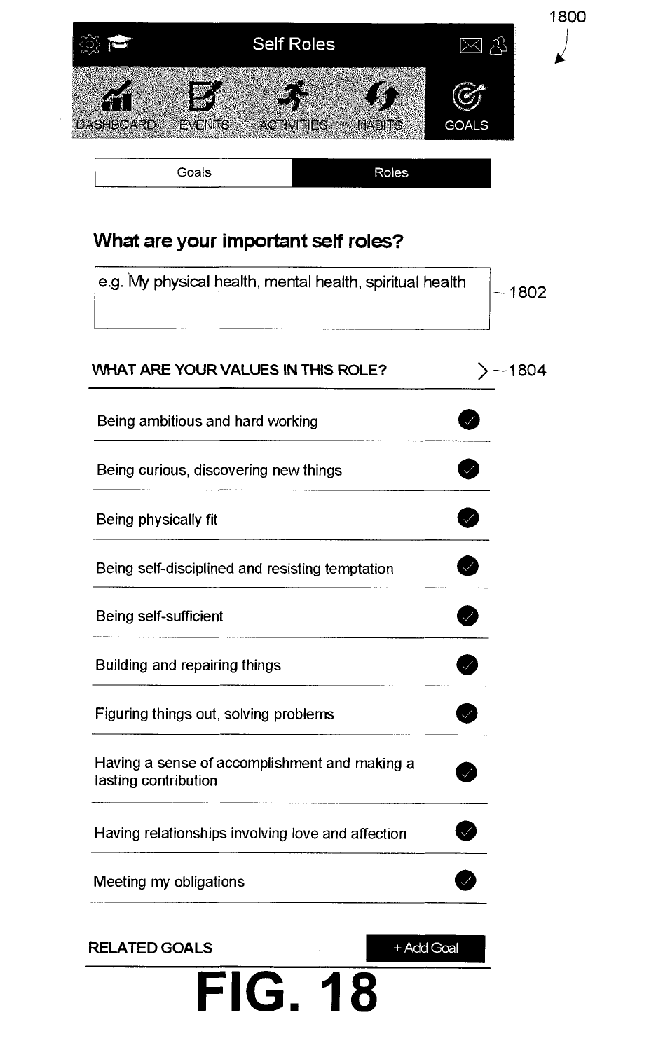

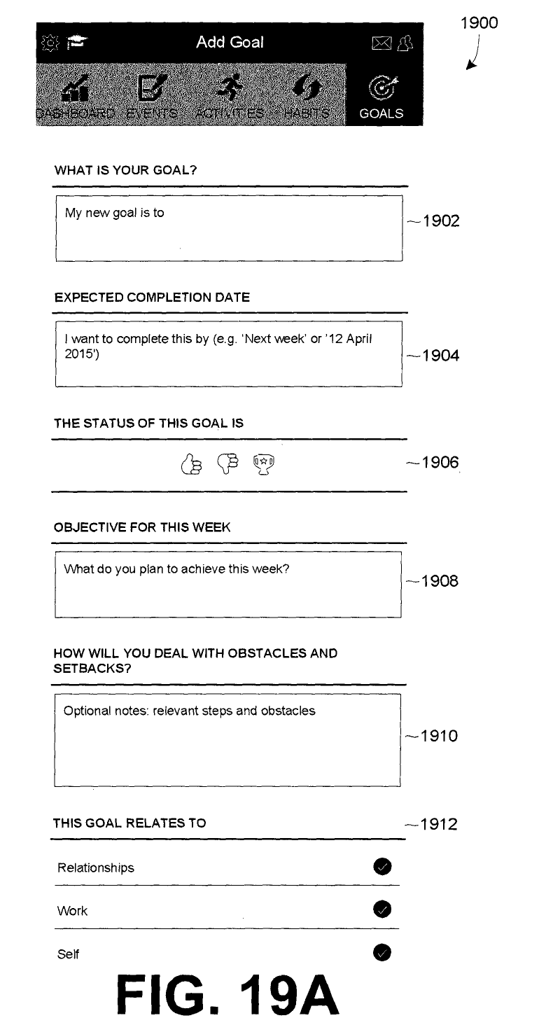

FIG. 18 is an example display 1800 in which a user can edit aspects of the roles 1710 shown in FIG. 17. In this display, the user can enter various self roles 1802, assign values 1804 associated with the selected role and relate goals 1806 to the selected role.

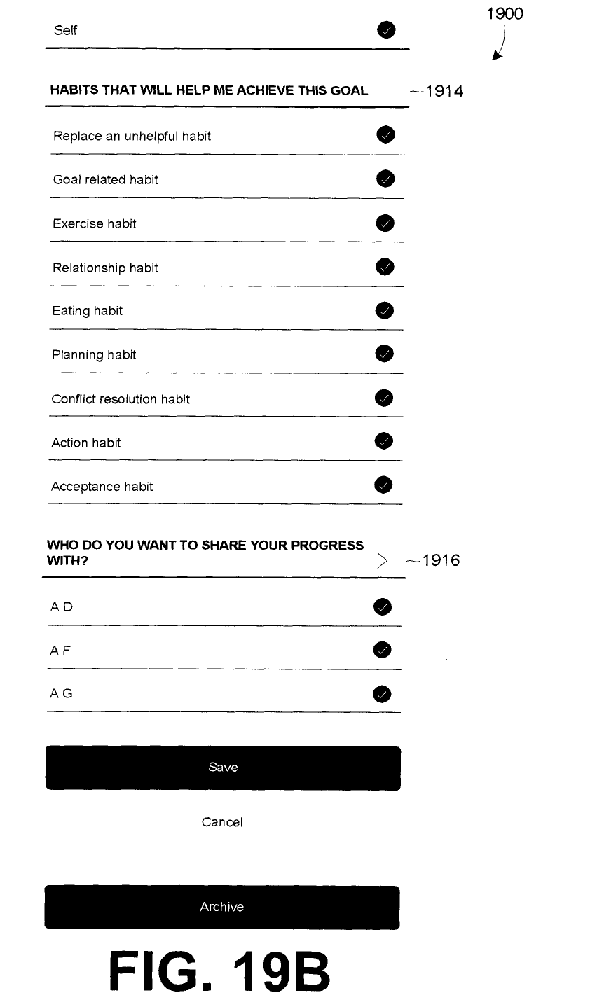

When adding a goal, the user can be directed to the example add goal screen 1900, as shown in FIGS. 19A and 19B. The user can enter the goal 1902 and the associated information, including the completion date 1904, the status of the goal 1906, a weekly objective 1908, an outline 1910 for achieving the goal 1902 and relating 1912 the goal 1902 to roles and habits 1914. The user can also choose supporters 1916 to share their progress on the goal 1902 with.

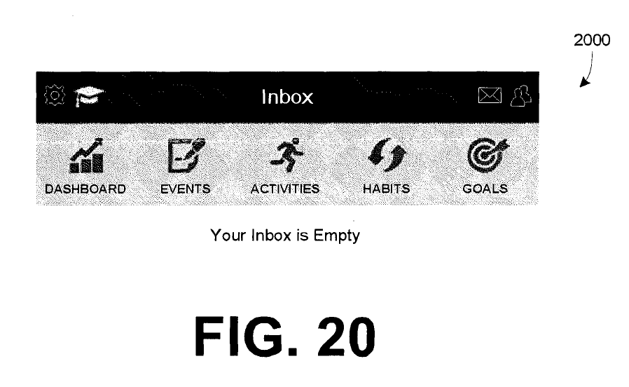

The user can also have an inbox 2000 as shown in FIG. 20. Supporters, practitioners, the system and/or others can send messages to the user, the user can then access the messages in the inbox 2000. Messages can include links to questionnaires and/or other activities for a user to complete.

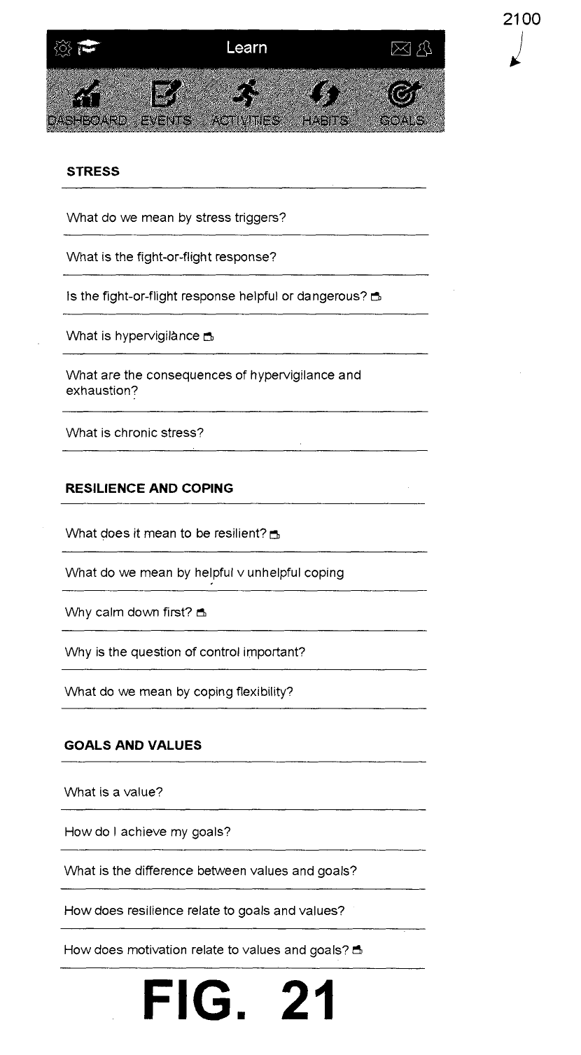

FIG. 21 is an example screen of a learning module 2100 that can be included in the behavioral learning system. The user can access the learning module 2100 to learn about different behaviors and behavior techniques, such as those shown.

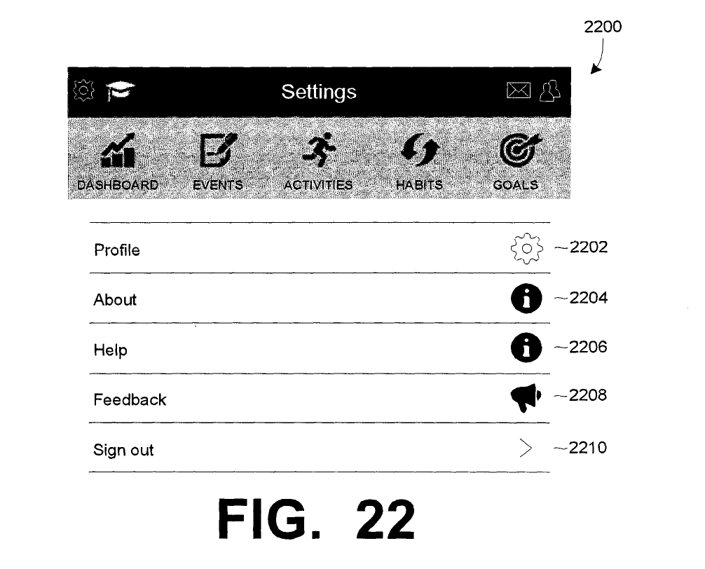

The user can access a settings screen 2200, as shown in FIG. 22, in which the user can modify various settings of the behavior learning system. The settings can include editing the user profile 2202, learning about system 2204, requesting help 2206 in using the system, submitting feedback 2208 about the system and signing out 2210 the user.

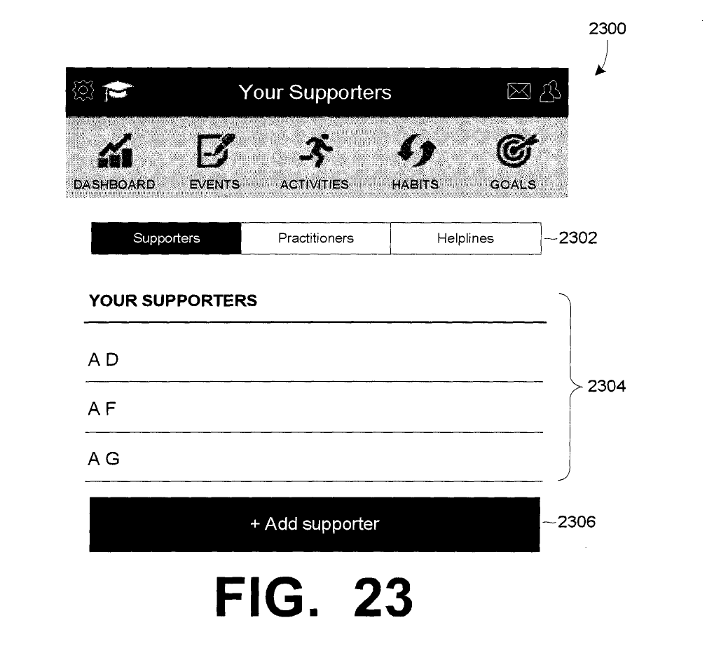

A user can also have supporters who can assist them and provide encouragement while the user is using the behavior learning system. The user's supporters can be managed using the example supporter screen 2300 as shown in FIG. 23. The user can use the toolbar 2302 to select the supporter type. The supporters of the selected type are listed 2304 and additional supporters can be added 2306. Additionally, the example supporter screen 2300 can include a “supporting” tab. Under this tab, the user can view other system users who they are supporting. The user is presented a newsfeed where they can see progress of the users they are supporting and offer encouragement and feedback.

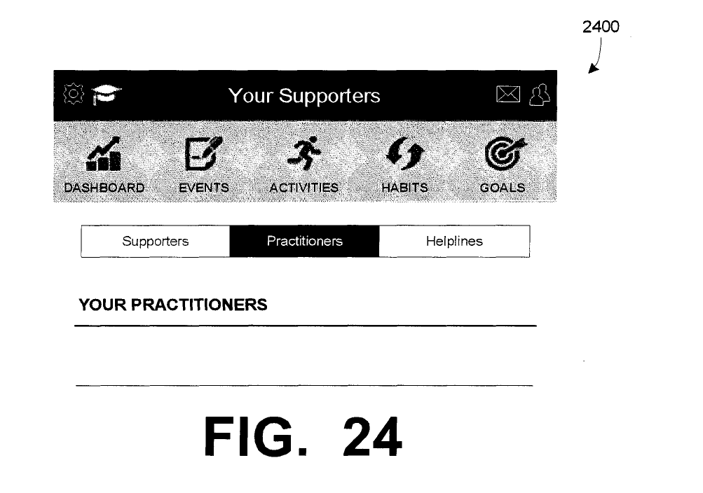

The supporters can include practitioners that can be listed in the example practitioner supporters screen 2400 as shown in FIG. 24. Supporting practitioners are able to see the user's progress from the practitioner's portal.

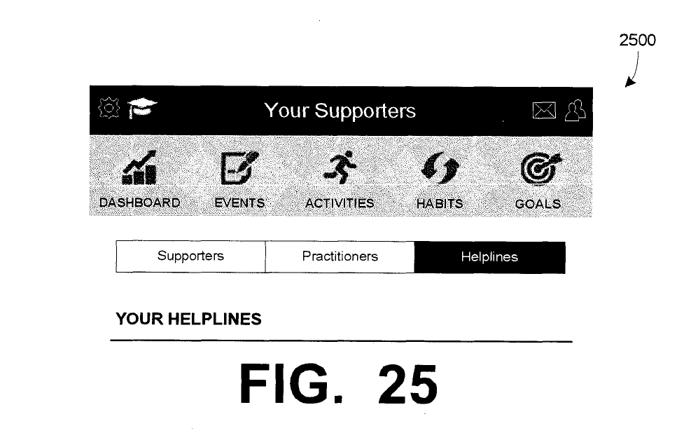

The user can also have helplines as supporters, the helplines can be shown in the helpline supporters screen 2500 as shown in FIG. 25. The user can access the relevant contact information for the supporter helplines through the screen 2500.

User supporters can include people the user knows, such as friends, acquaintances, sponsors and the like. Additionally, supporters can be other users that are participating in or have participated in the behavioral learning system.

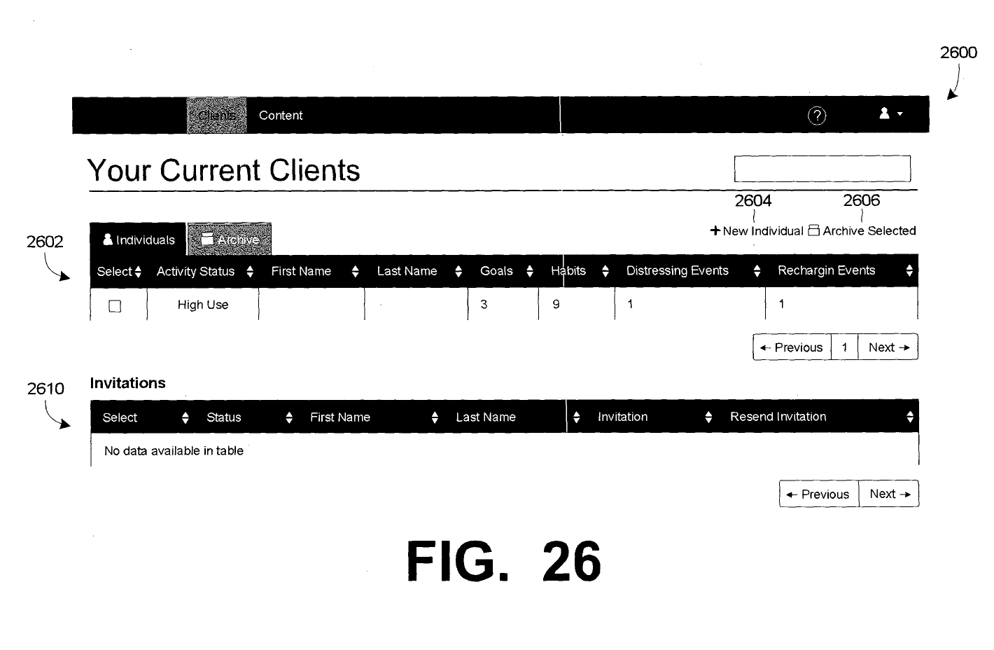

Practitioners supervising users who are using the behavior learning system can access the system through a practitioner side of the system. Practitioners can encounter the example practitioners screen 2600 as shown in FIG. 26. Practitioners can see a list 2602 of the current users the practitioner is overseeing. New users can be added 2604 by the practitioner and users that are done with the behavior learning system and/or are not overseen any longer by the practitioner can be archived 2606. The archiving process retains the user information but removes the user from the active client list of the practitioner. If the practitioner adds a new user, the user can be listed under the invitations 2610, until the user has accepted the invitation and is registered with the behavior learning system. Once registered, the user can become an active client of the practitioner.

It will be understood that the practitioner can preferably be a licensed health care professional or performance coach. However, a person managing a group of users, such as a trainer, can also be considered a practitioner within the behavior learning system. Such a person can manage users through the practitioner's portal.

Further, it is also understood that all of the practitioner editable properties or fields associated with behavior learning system can feature menus having prepopulated options for the practitioner to select from or can feature free inputs such that the practitioner can input any content as desired.

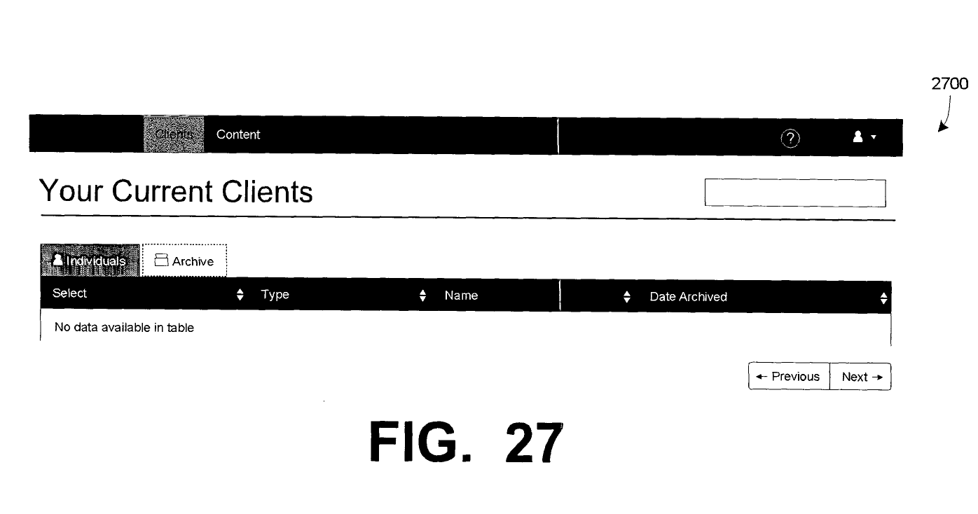

Inactive clients can be archived by the practitioner and/or the behavior learning system. Archived clients or users can be viewed by the practitioner using the example archive screen 2700 as shown in FIG. 27.

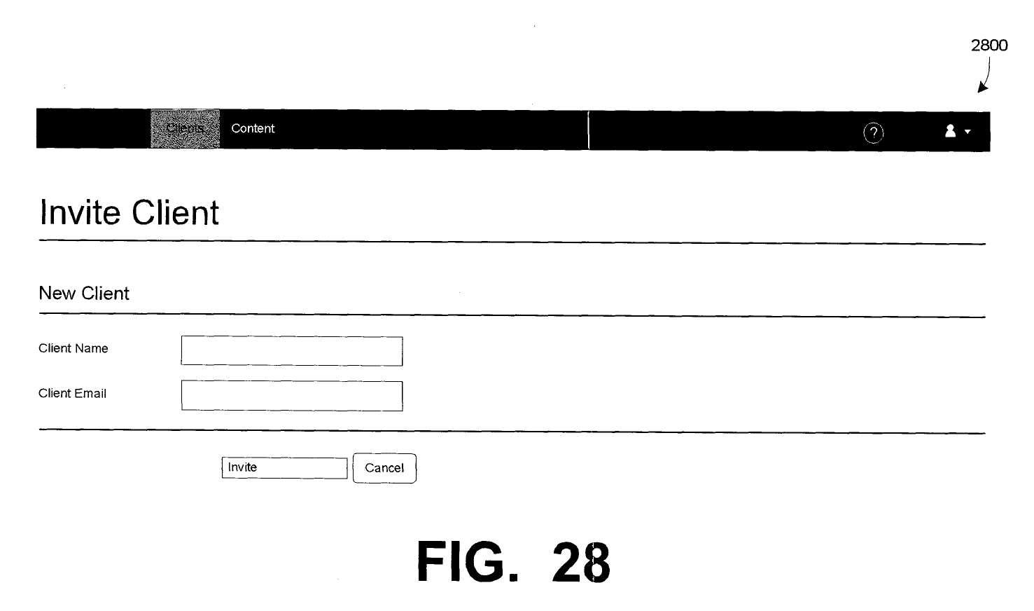

FIG. 28 shows an example client invite screen 2800. The practitioner submits the user's name and email through the invite screen 2800, the behavior learning system can then send an email to the supplied address, providing the necessary information for the user to register themselves within the behavior learning system. The user is associated with a practitioner through the invitation process.

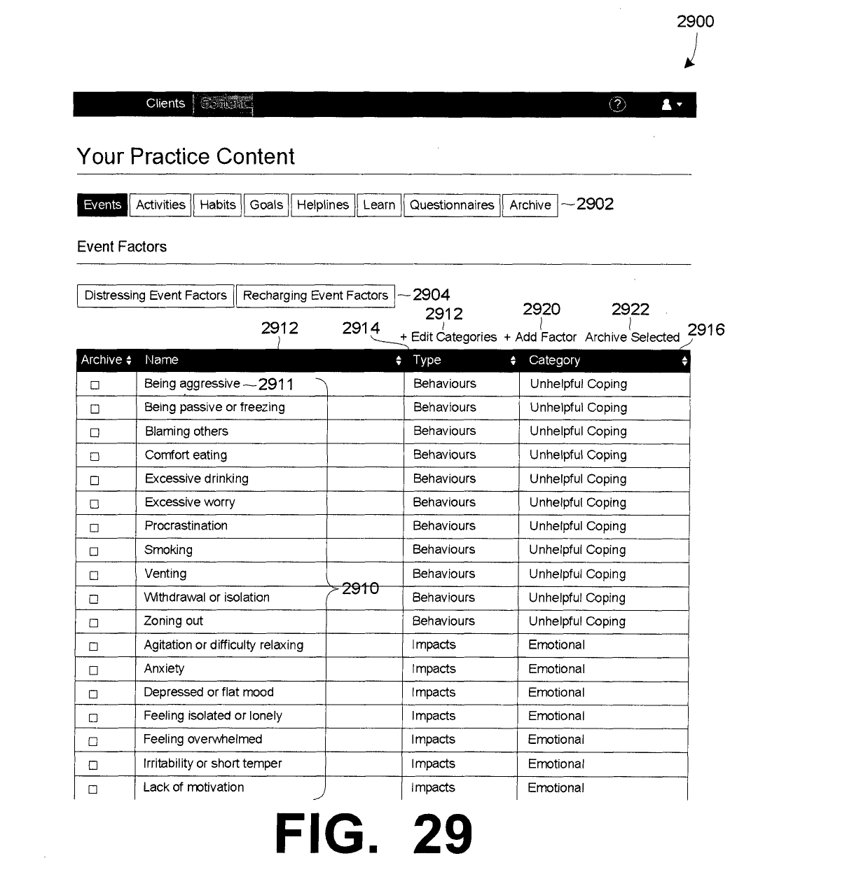

Practitioners can access their content library through an example practice content screen 2900, as shown in FIG. 29. The practitioner can select a content profile 2902, for which the behavior learning system will then display the available content 2910 for the selected profile. Some content profiles can include sub-profiles 2904. The available content 2910 can be organized, allowing the practitioner to view the content name 2912, the content type 2914 and the content category 2916. The various content properties can be used to sort the content as desired by the practitioner. The practitioner can also add categories 2920 of content and add event factors 2922 that can be associated with content. From the available content 2910, the practitioner can customize the content they feel is useful or most applicable to them Limiting the available content 2910 on the practitioner level can simplify the content assignment to a user which is performed in a different screen.

In the example practice content screen 2900, shown in FIG. 29, the practitioner is viewing the content associated with distressing events for the user. The content listed has associated properties the user will be able to select from associated with an event logging, such as the example screen 800 of FIG. 8.

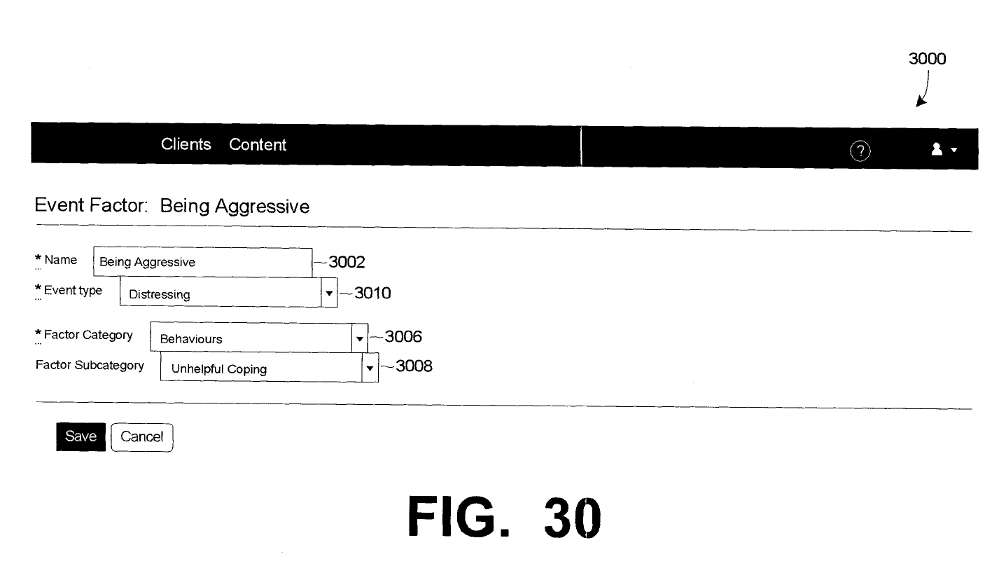

A content item, such as an event factor 2911 as shown in FIG. 29, can be edited by the practitioner using the example event factor edit screen 3000 as shown in FIG. 30. The name 3002, the event type 3010, factor category 3006 and factor subcategory 3008 of the event factor 2911 can be edited by the practitioner through the examples event factor edit screen 3000.

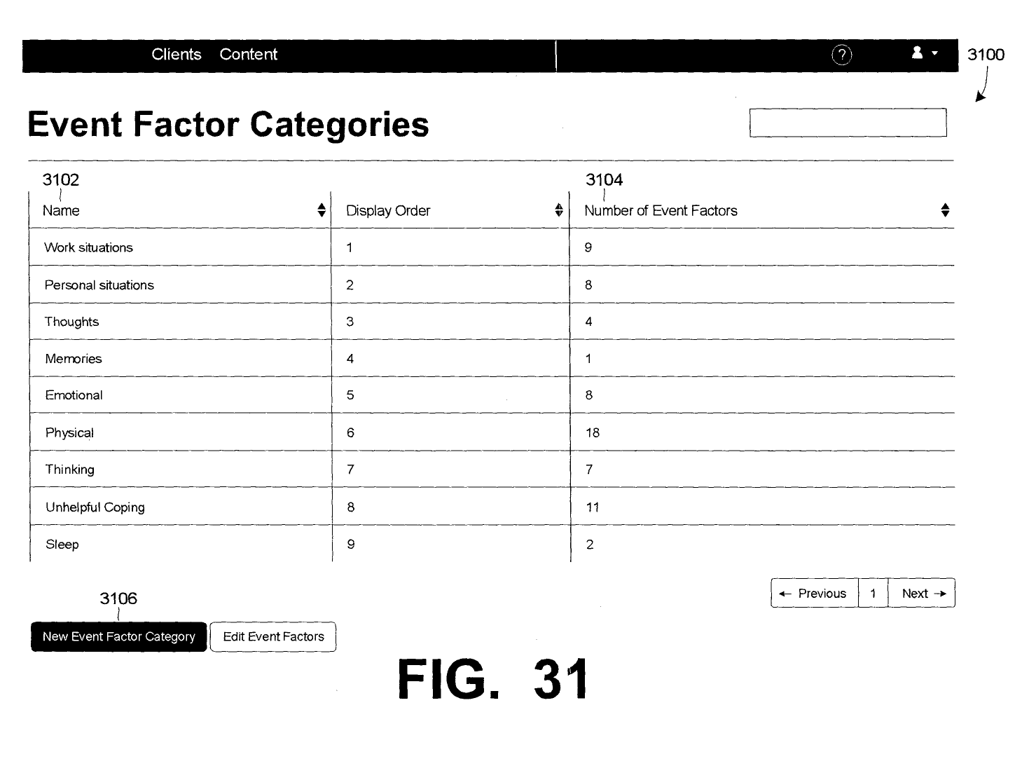

The practitioner can edit the categories of the content using the example categories edit screen 3100 of FIG. 31. The practitioner can order the categories 3102, view the number of factors associated 3104 associated with each category and add categories 3106. A category can also be deleted or removed from the available categories by the practitioner. The name or title of an existing category can be edited by the practitioner.

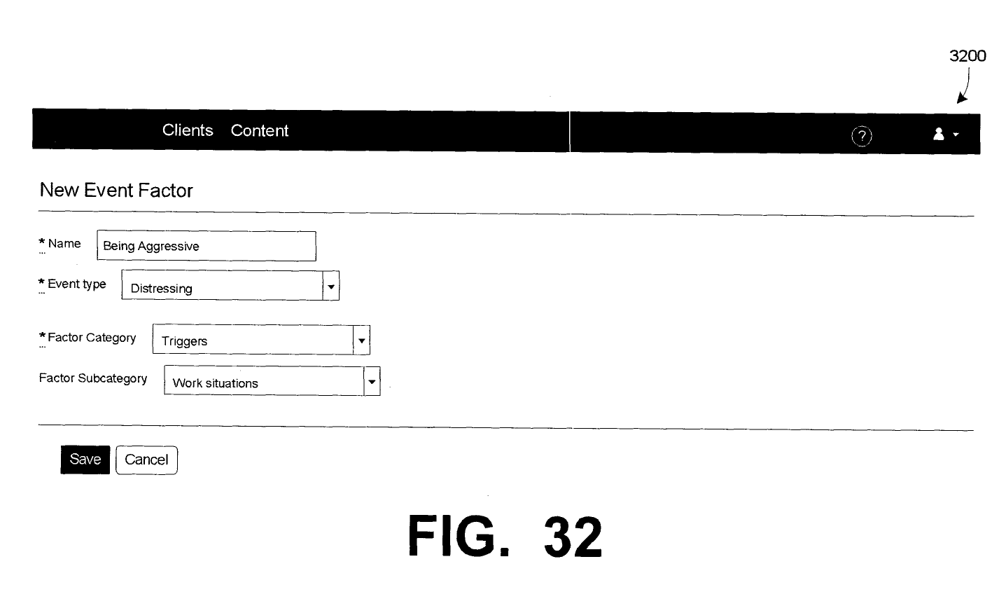

New event factors can be added by the practitioner using the example new event factor screen 3200 of FIG. 32. The practitioner can create an event factor, associating the event factor with an event type, a factor category and a factor subcategory.

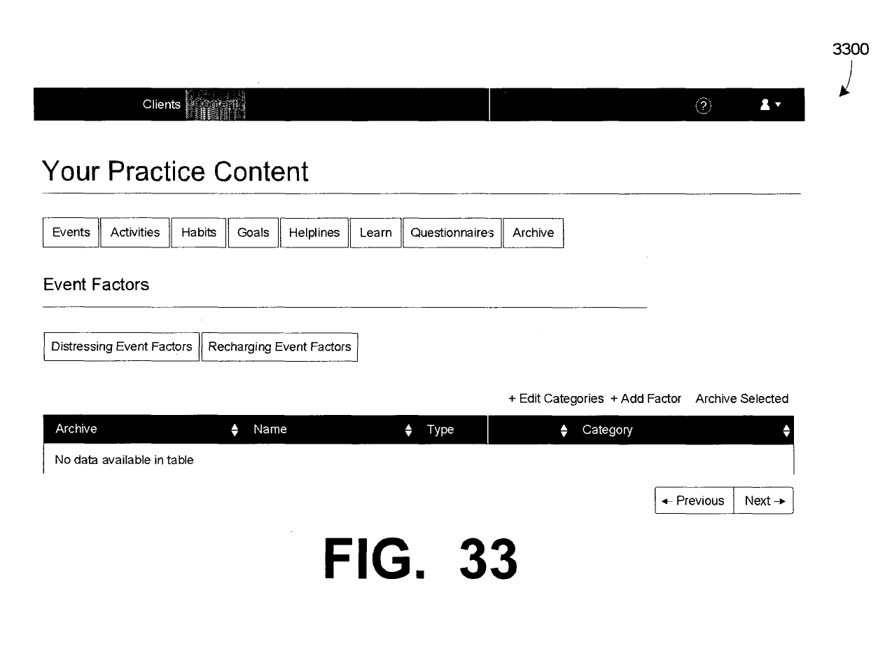

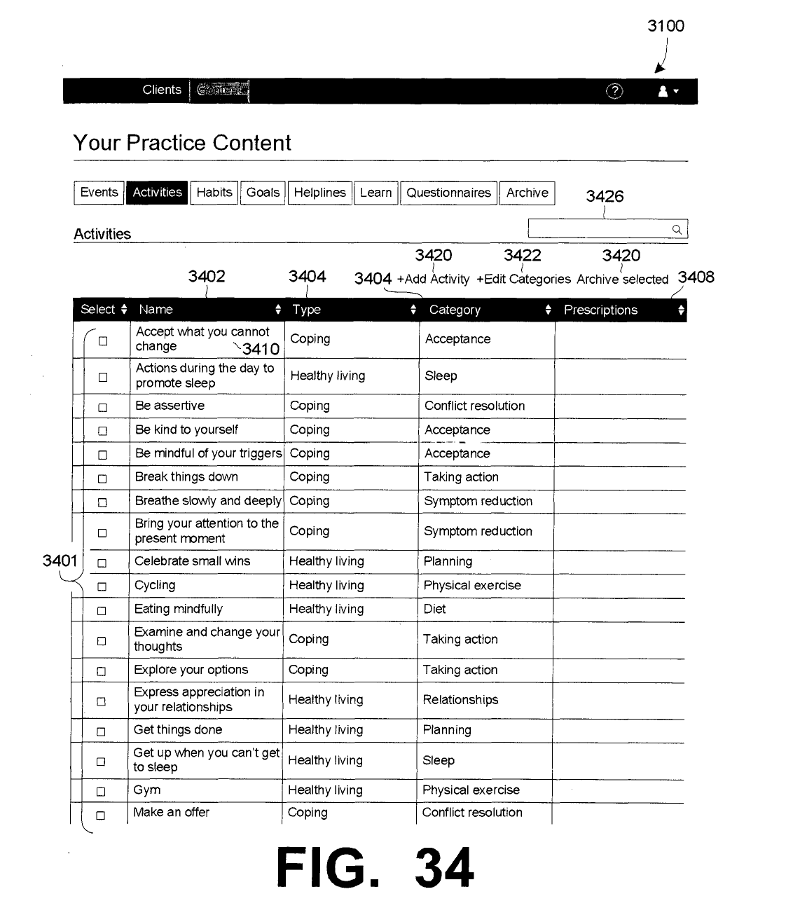

FIG. 33 shows an example recharging event factor content screen 3300 wherein the practitioner can view the available content associated with recharging events within the behavior learning system. As with the example distressing event screen 2900 of FIG. 29, similar screens and tool are provided to the practitioner so that they can edit the content available or viewable by the user.

An example activities content screen 3400 is shown in FIG. 34. In the example activities content screen 3400, the practitioner can view the various activities 3401 available to a user. Each of the available activities 3401 has a name 3402, an activity type 3404, and an activity category 3406 associated with it. A prescription 3408 represents an association between an activity and event factor. The prescription can also have a prescription strength associated with it. The prescription strength can be based in part upon an event factor. In this way, the practitioner can prescribe an activity for different event factors, with each prescription having a strength rating. This allows the practitioner to identify the most relevant event factor for prescribing an activity. The prescription strength can be input on a system level, calculated by the system or assigned by a practitioner on a user or users basis. The practitioner, similar to event factors, can add activities 3420, edit activity categories 3422, and archive selected activities 3424. The practitioner can also search for activities using the search tool 3426.

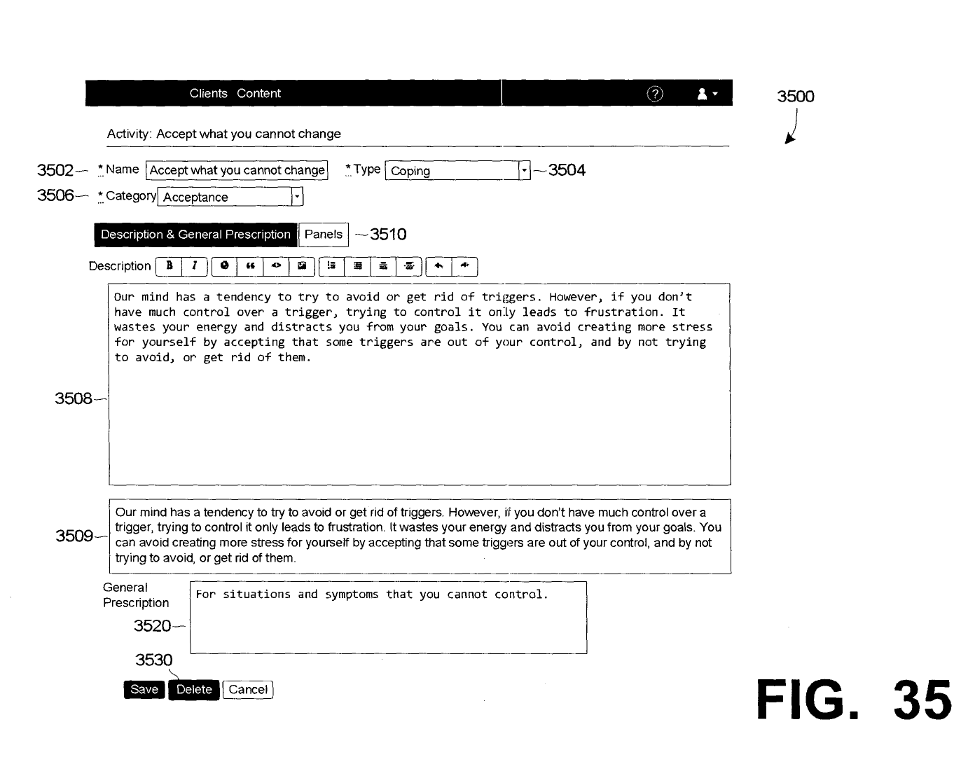

An individual activity 3410 can be edited by the practitioner using the example activity edit screen 3500 as shown in FIG. 35. The practitioner can edit the name 3502 of the activity and the type 3304 and category 3506 associated with the activity. The practitioner can also edit the text or description 3508 associated with the activity, a display 3509 can be provided to preview how the text will look within the behavior learning system. A panels tab 3510 can also be accessed by the practitioner. The panels, such as 1110 of FIG. 11, contain content or exercised associated with the activity. A prescription 3520 can also be associated with the activity and can be edited by the practitioner. Additionally, the practitioner can delete 3530 the activity 3410.

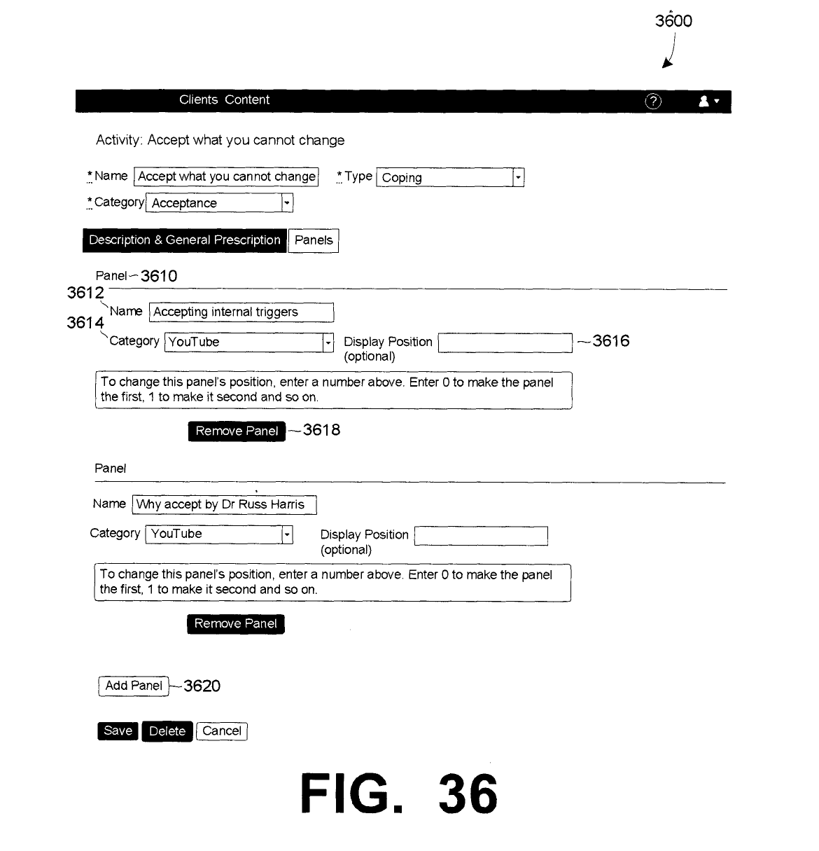

FIG. 36 shows an example panel edit screen 3600 that a practitioner can use to edit the panels associated with the activity. Each panel 3610 has a name 3612, category 3614 and position 3616 associated with it. The practitioner can edit an existing panel 3610, remove a panel 3618 and/or create a new panel 3620. The panel category 3614 associates a content type with the panel 3610, such as a video, sound, text, image or exercise. The content can be external or internal to the behavior learning system. If the content is external in nature, the practitioner can use a link to embed the content within the behavior learning system. If multiple panels are present, they can be arranged by the practitioner in a desired order using the position 3616 tool.

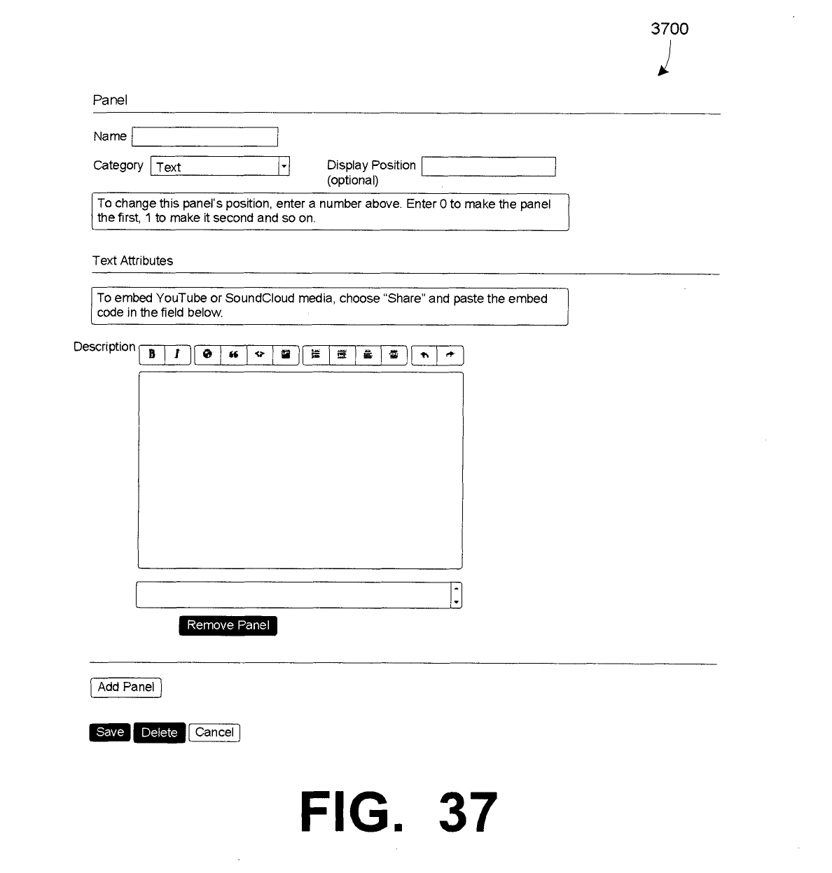

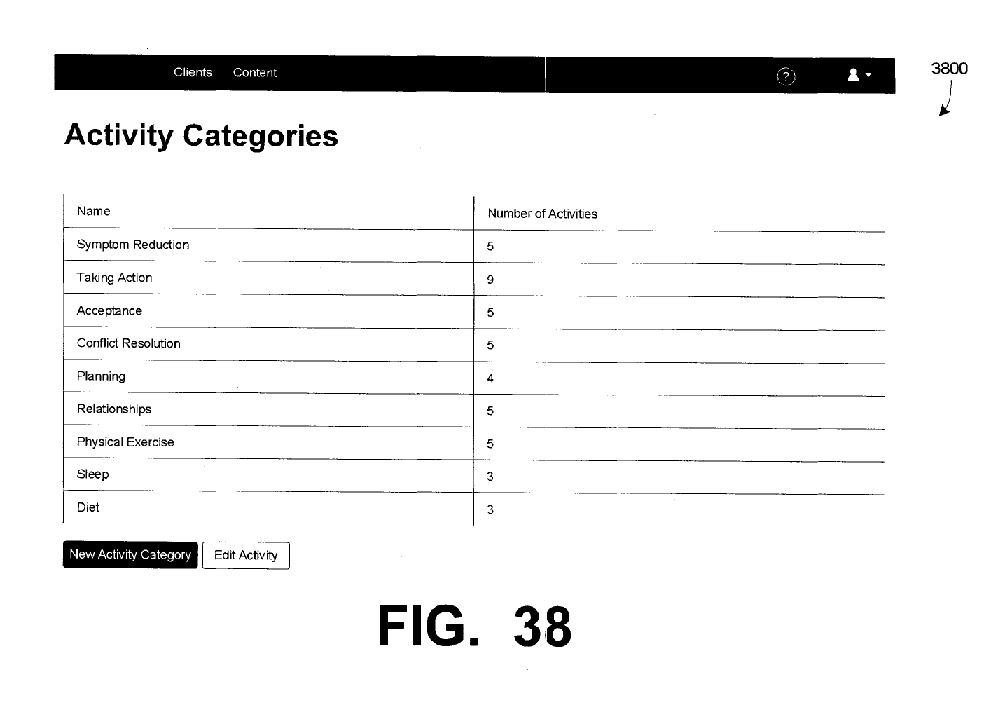

FIG. 37 shows an example add activity screen 3700. The practitioner can add an activity to their content using the input screen 3700. The inputted information is similar to that of the edit activity screen 3500 of FIG. 35 and panel edit screen 3600 of FIG. 36.

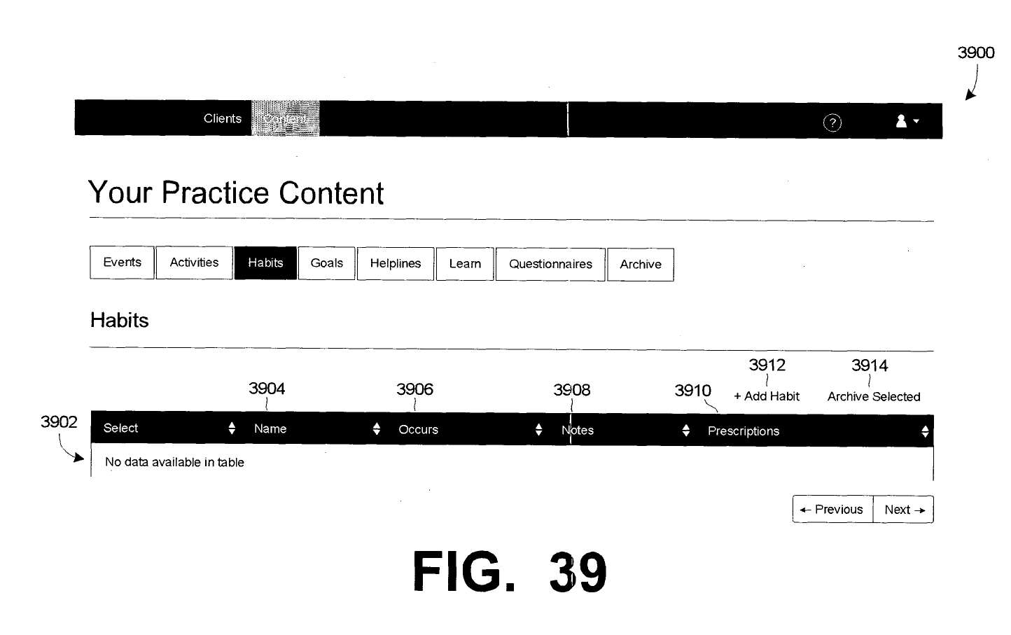

FIG. 38 shows an example categories edit screen 3800 for the activities content. The practitioner can view, add and organize the categories associated with activities and can view the quantity of activities associated with each category.

FIG. 39 is an example habits content screen 3900 listing the standard habits. Habits listed here will be added by default to all new clients added by the practitioner. The habits available 3902 are listed, each habit can have a name 3904 (the behavior), an occurrence 3906 (when to perform that behavior), notes 3908 and/or a prescription 3910 (why the habit is helpful) associated with it. The practitioner can edit, add 3912 and/or archive 3914 a habit(s).

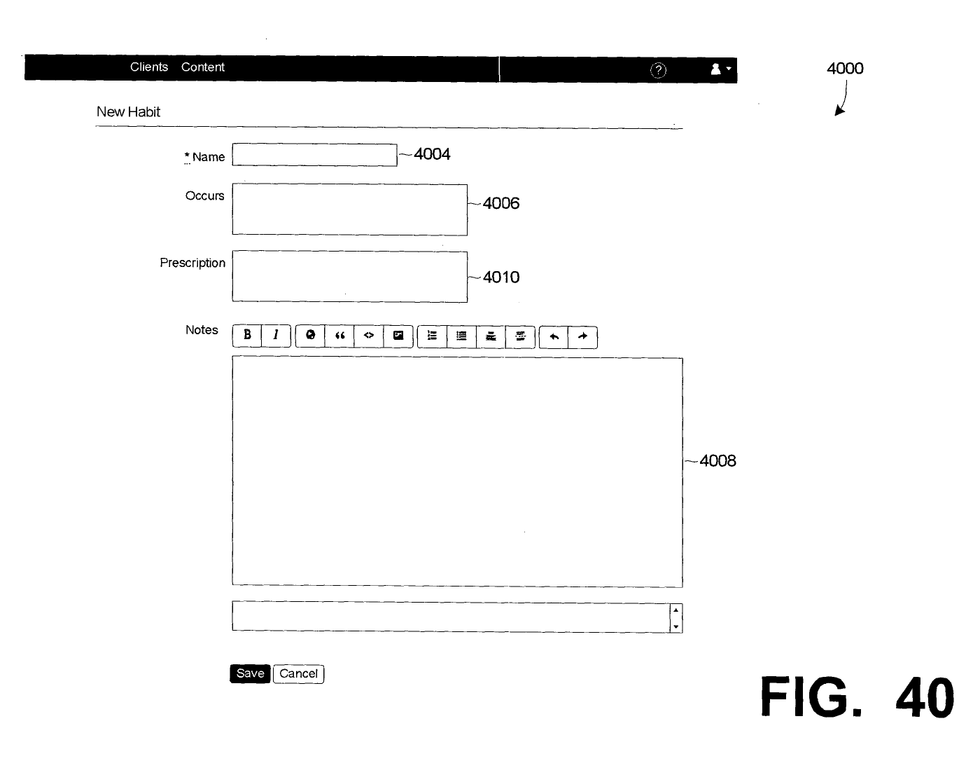

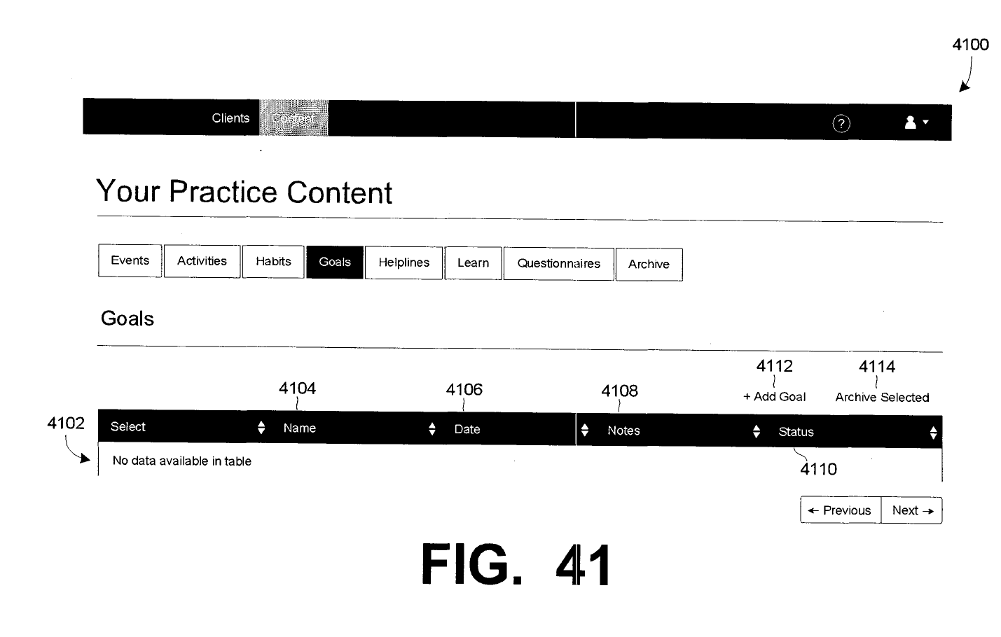

FIG. 40 shows an example add habit screen 4000. The practitioner can assign the habit a name 4004, an occurrence 4006, a prescription 4010 and/or notes 4008. A preview 4010 can be provided so the practitioner can preview how the notes and/or activity will appear within the behavior learning system.

Standard goals can be reviewed by a practitioner in the example goals content screen 4100 as shown in FIG. 41. Goals listed here will be added by default to all new clients added by the practitioner. The goals content items 4102 are listed. Each goal content item can be associated with a name 4104, a date 4106, notes 4108 and a status 4110. The practitioner can add 4112 and archive 4114 goal items.

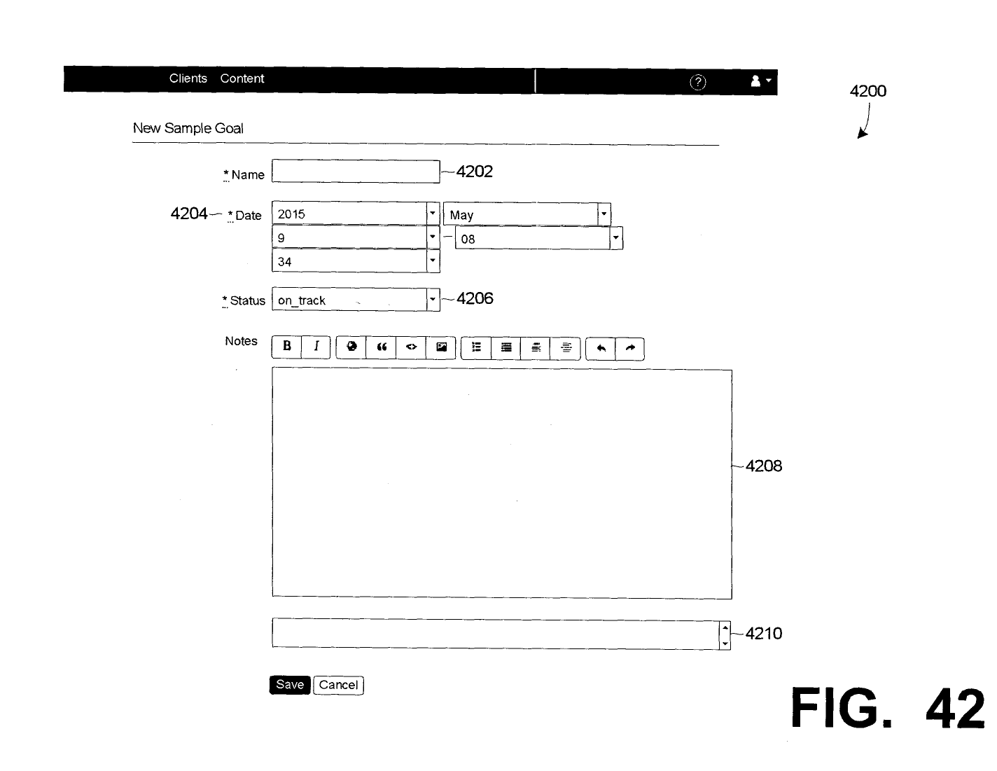

FIG. 42 shows an example add goal screen 4200. The practitioner can input the pertinent information regarding the new goal on the screen 4200, such information can include the name of the goal 4202, the timeline to finish the goal 4204, the current status of the goal 4206 and/or notes 4208 associated with the goal. A preview 4210 can also be provided such that the practitioner can preview how the goal and/or notes will appear within the behavior learning system.

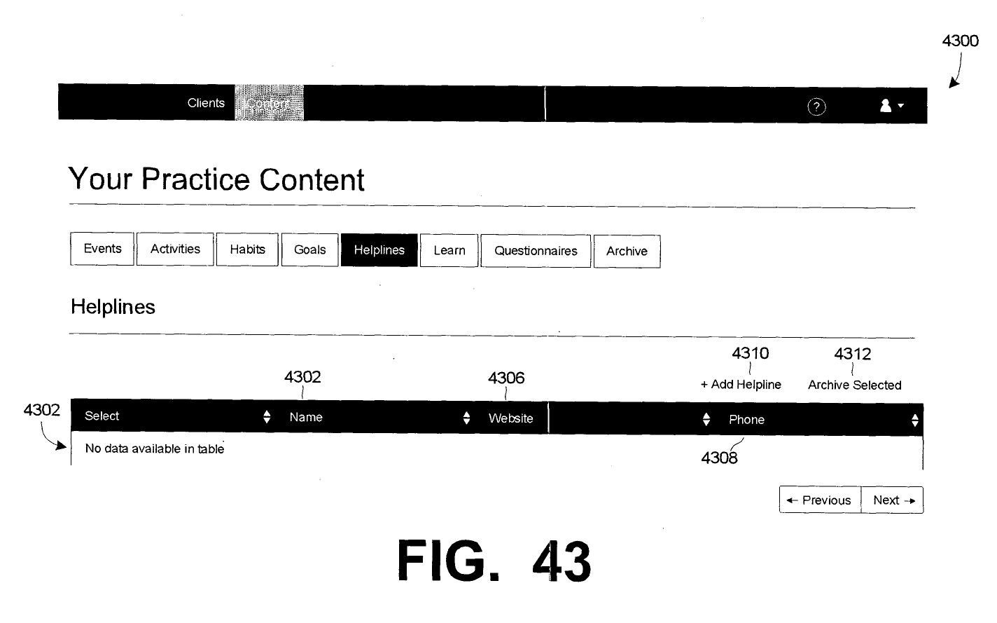

The practitioner can also provide helplines to the user, the helpline content can be displayed as in the example screen 4300 of FIG. 43. The helpline items 4302 can be displayed, and each helpline item can be associated with a name 4304, a website 4306 and/or a phone number 4308. The practitioner can add 4310 and archive 4312 helpline items 4302.

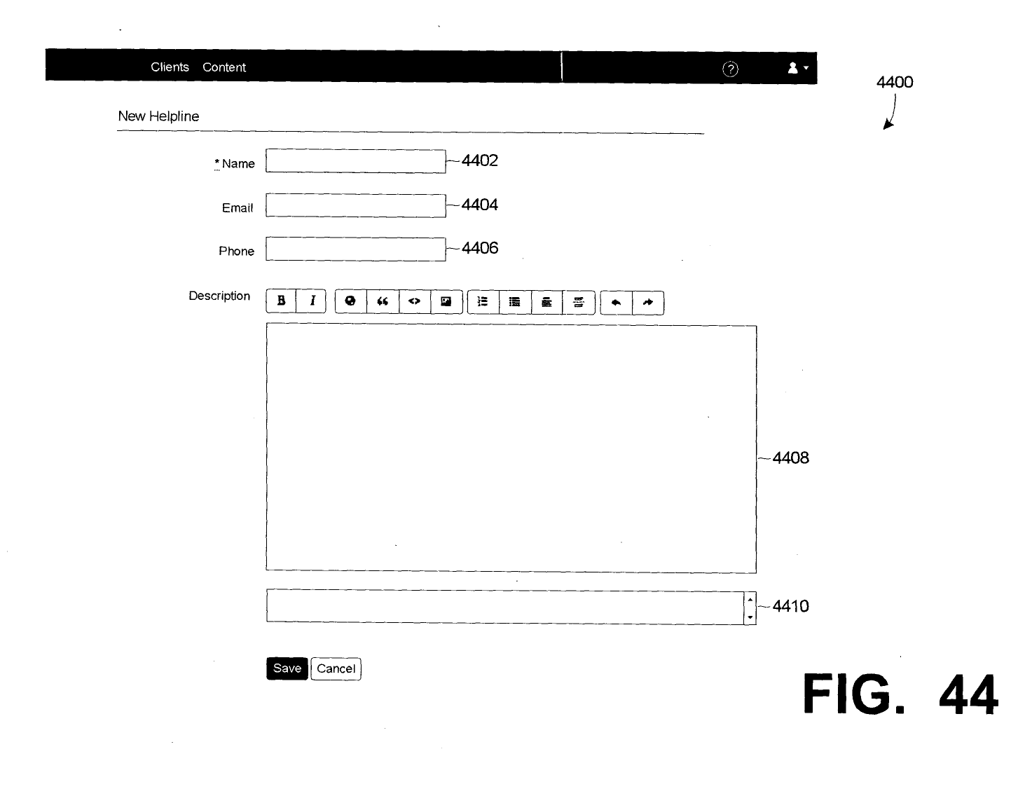

FIG. 44 shows an example add helpline screen 4400. The practitioner can input the name 4402, the email 4404, website, phone number 4406 of the helpline along with a description 4408 of the helpline. A preview 4410 can also be provided such that the practitioner can preview how the helpline and/or description will appear within the behavior learning system.

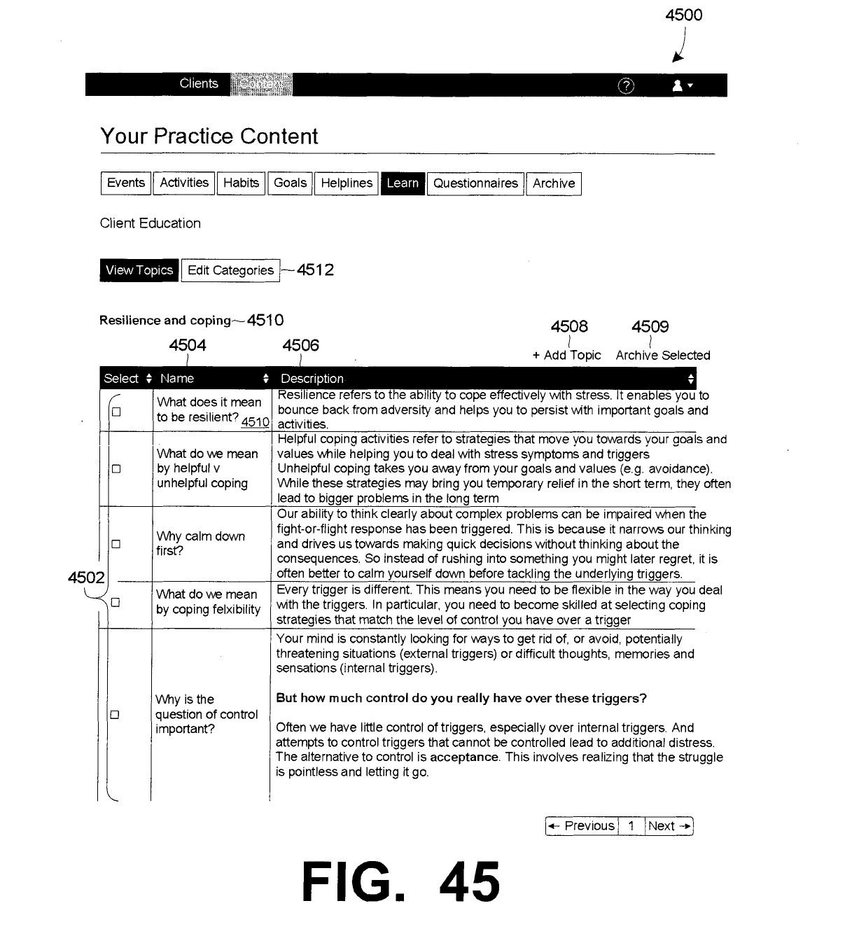

Client or user education content can be managed by a practitioner using the example screen 4500 as shown in FIG. 45. Education topics 4502 are listed and each topic can be associated with a name 4504 and a description 4506. The practitioner can add 4508 and archive 4509 topics. The practitioner can also edit 4512 categories 4510 in which the education content 4502 is organized into.

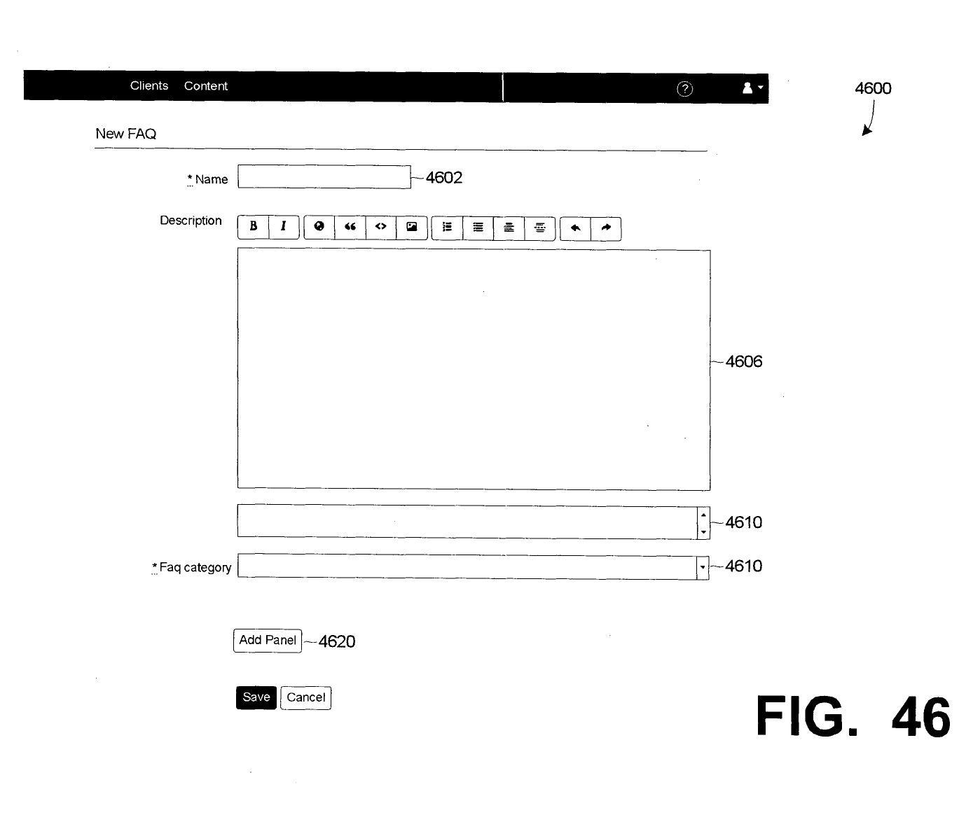

FIG. 46 is an example education topic edit screen 4600, the topic addition screen includes the same or similar features to the edit screen. A practitioner can use the topic edit screen 4600 to edit or modify various aspects of the topic content, such as the topic name 4602, the topic description 4606 and the category 4608 under which the topic appears. A preview 4610 can also be provided such that the practitioner can preview how the education topic description will appear within the behavior learning system. Additionally, the practitioner can add 4620 panels like those featured in the activities content. The practitioner can add content that is external or internal to the behavior learning system, the content appearing in panels under the selected topic.

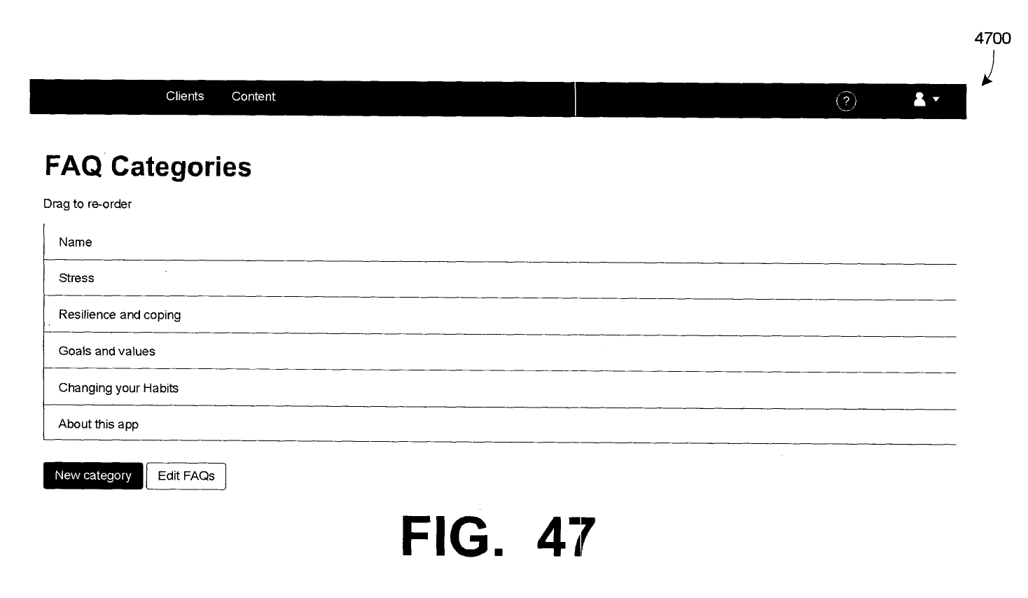

FIG. 47 is an example education category edit screen 4700. The practitioner can add, edit and/or reorganize the education categories.

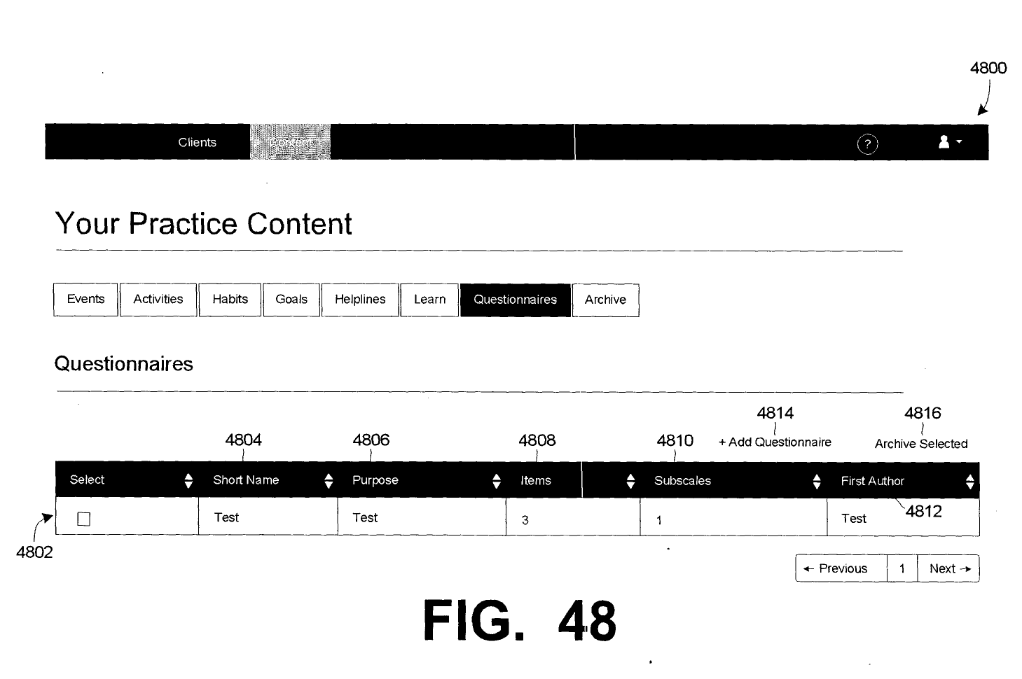

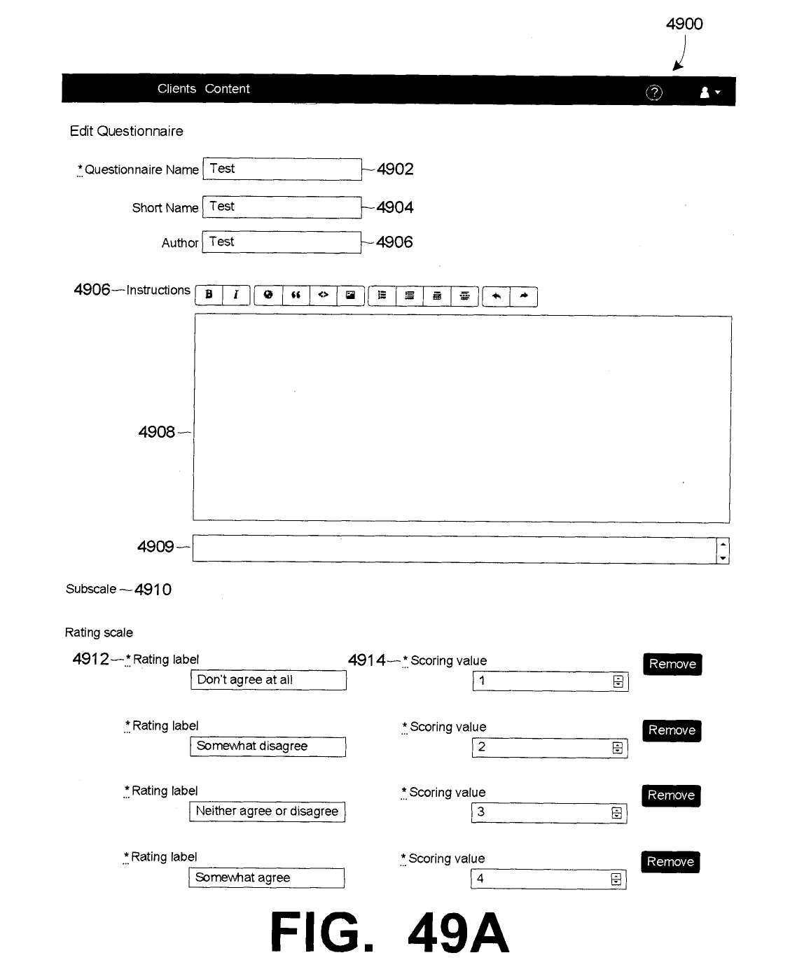

Questionnaires can be created by practitioners or others and distributed to users. FIG. 48 shows an example questionnaire content screen 4800. The questionnaires 4802 are listed, each questionnaire can be associated with a name 4804, a purpose 4806, the number of items in the questionnaire 4808, the number of subscales 4810 used to quantify the items of the questionnaire, and an author 4812 of the questionnaire. The practitioner can also add 4814 and archive 4816 selected questionnaires.

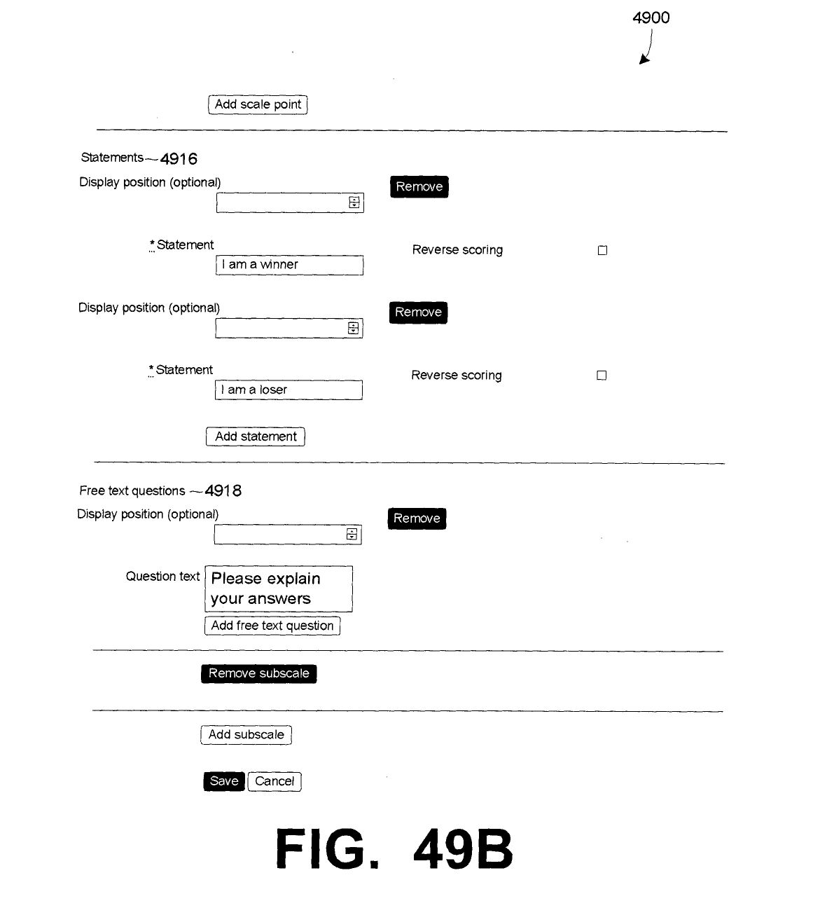

FIG. 49 shows an example questionnaire add/edit screen 4900. The practitioner inputs the pertinent information to create a questionnaire. The name 4902, a shortened name 4904, the author 4906 and a description 4908 of the questionnaire can be entered in the screen 4900. A preview 4909 can also be provided such that the practitioner can preview how the description will appear within the behavior learning system. A subscale 4910 can be created; the subscale 4910 can include a rating label 4912 and a scoring value 4914. Statements 4916, to be graded according to a subscale, can be added to the questionnaire. Free text questions 4918 can be added to the questionnaire, allowing a user to input any data in response to the free text question 4918. The user response to the free text question 4918 can be reviewed by the practitioner later to generate an assessment of the user's response to the question 4918.

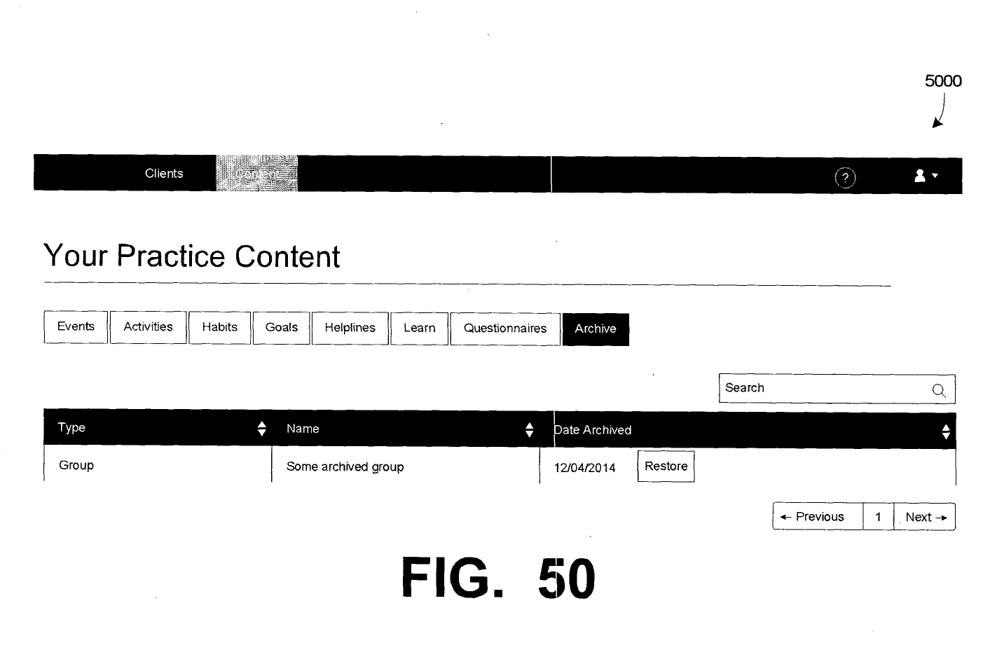

FIG. 50 shows an example archive content screen 5000. The practitioner can view archived content, including groups, in the screen 5000. The practitioner can restore the archived content into the main behavior learning system.

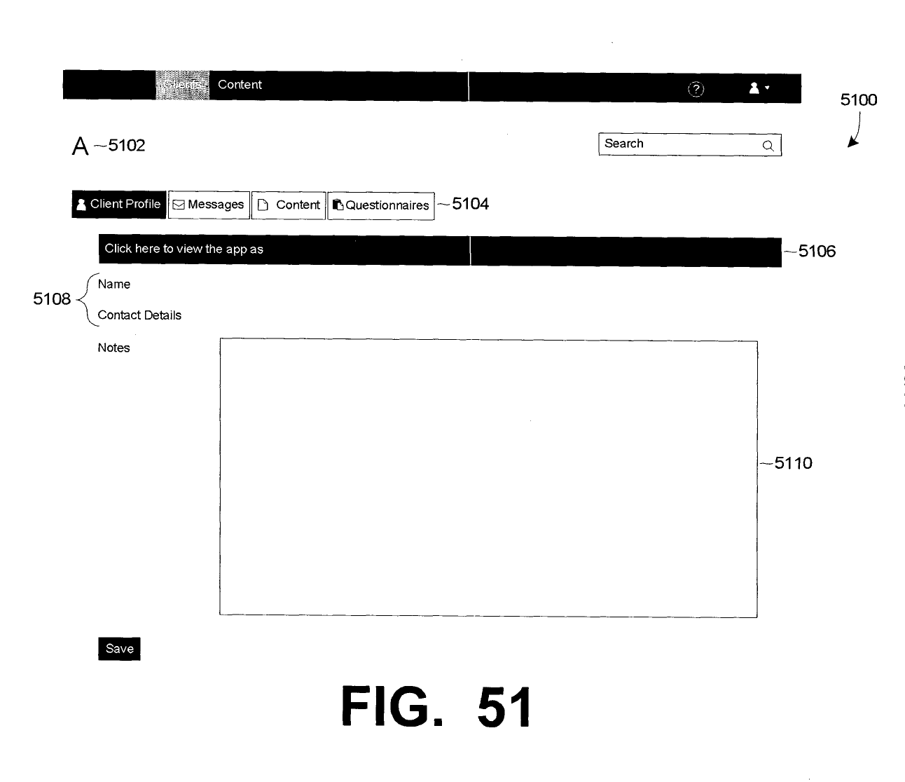

Practitioners can access a specific client, to tailor or refine the behavior learning system for a specific user the practitioner is managing or supporting. An example client management screen 5100 is shown in FIG. 51. The client 5102 is indicated and a toolbar 5104 can allow the practitioner to navigate between various client management options. Client contact information 5108 is listed and the practitioner can enter client specific notes 5110. Additionally, the practitioner can view 5106 the behavior learning system as the client in order to see the content as would be displayed to the client or user.

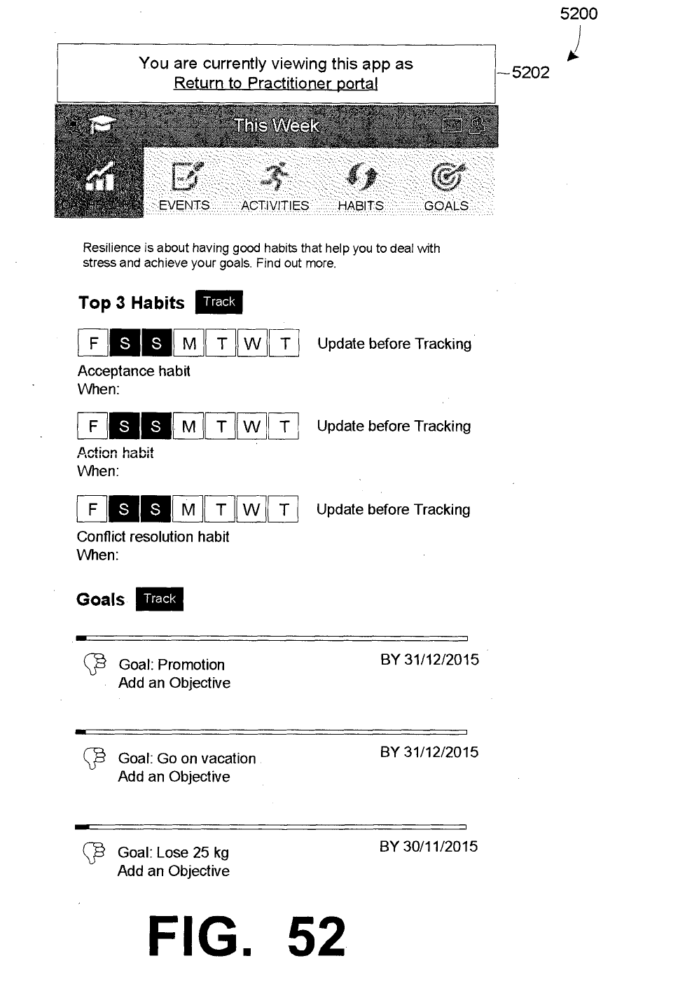

FIG. 52 is an example client view screen 5200, accessed through the practitioner portal. In this screen, the practitioner is viewing the behavior learning system as if they were the client, the practitioner can return to the practitioner portal 5202 using the provided access.

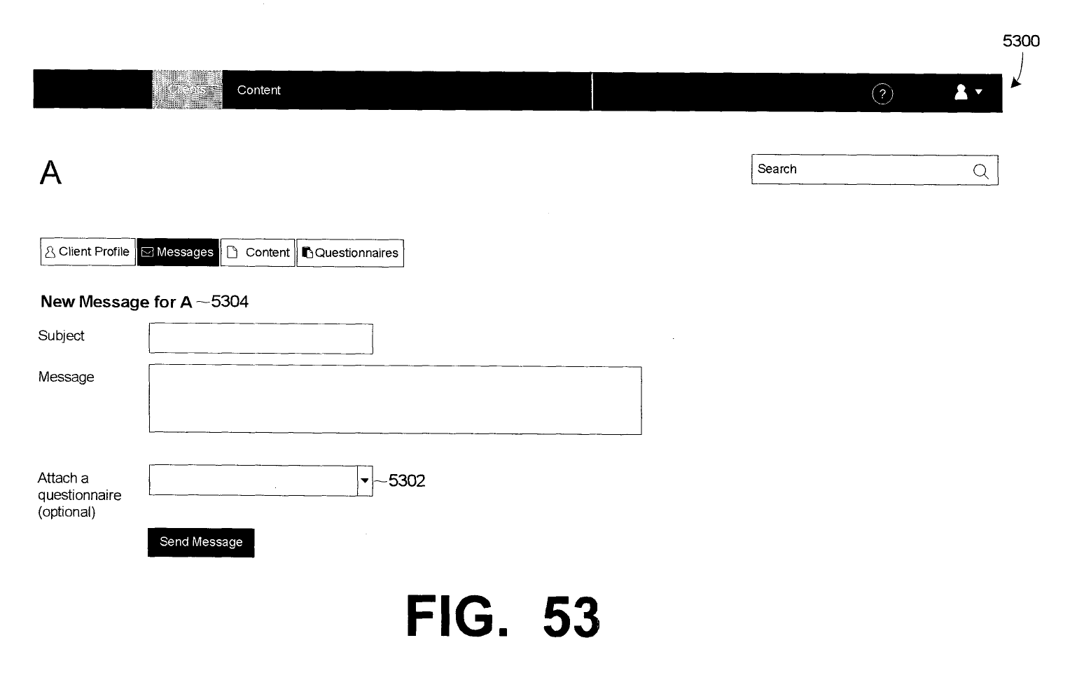

FIG. 53 is an example client message screen 5300, through which the practitioner can send a message to the client using the integrated messaging within the behavior learning system. The practitioner can compose a message 5304 and can attach a questionnaire 5302 for the user to complete.

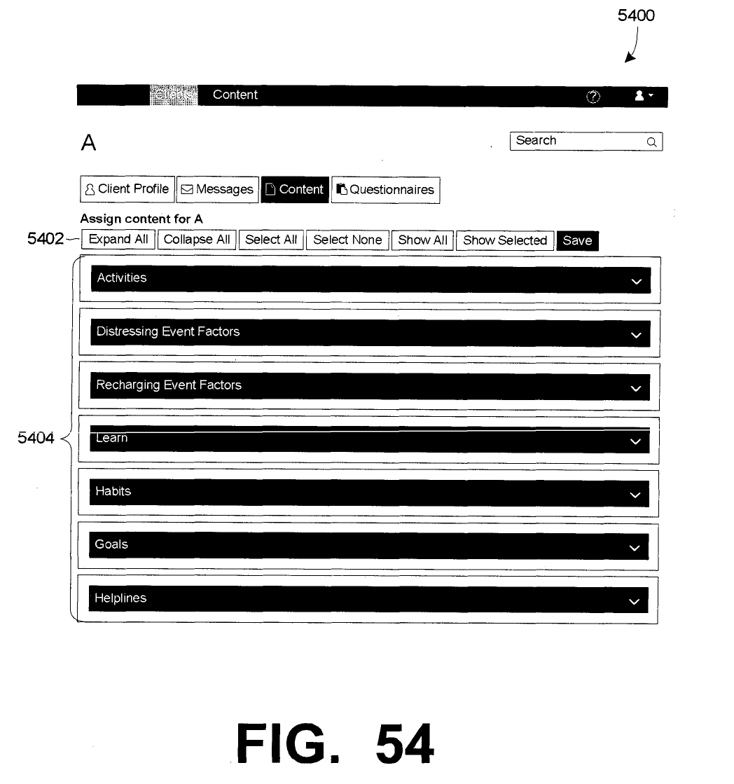

FIG. 54 is an example client content assignment screen 5400. The practitioner can assign the client specific content from various content categories 5404. A tool bar 5402 is provided to assist the practitioner in assigning client content.

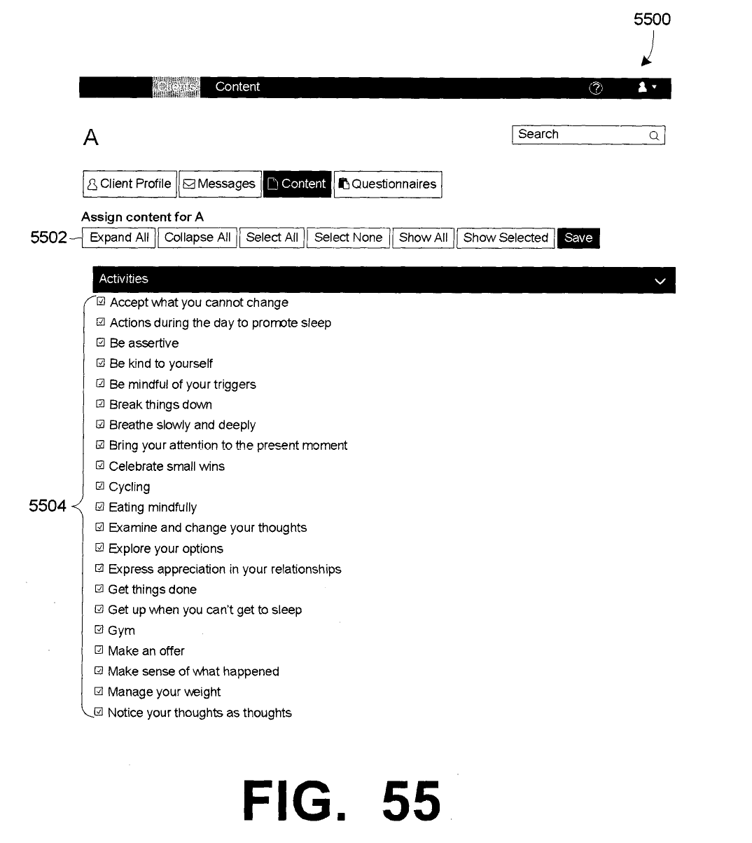

FIG. 55 is another example client content screen 5500, showing an expanded content category 5502 and the content 5504 listed therein. The practitioner can use the check boxes to select or remove content to be available to the selected client. Content profiles may also be provided such that the practitioner can select a behavior, the client available content then being automatically narrowed to pre-selected content associated with the selected behavior.

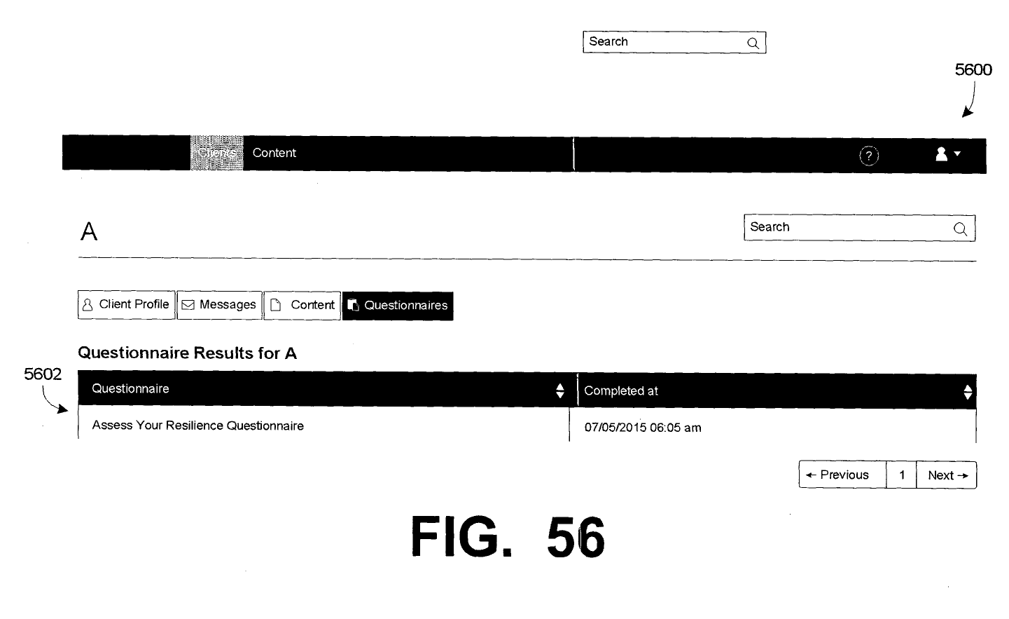

FIG. 56 is an example client questionnaire screen 5600. The practitioner can view the questionnaire(s) 5602 completed by the client or user. A time stamp for the completion of the questionnaire can also displayed, as can a score for the questionnaire. The practitioner, when preparing the questionnaire, can assign or create a scoring rubric for the questionnaire. Once the questionnaire is completed by the client or user, the behavior learning system can apply the scoring rubric to score the questionnaire. The questionnaire score can be displayed in the client questionnaire screen.

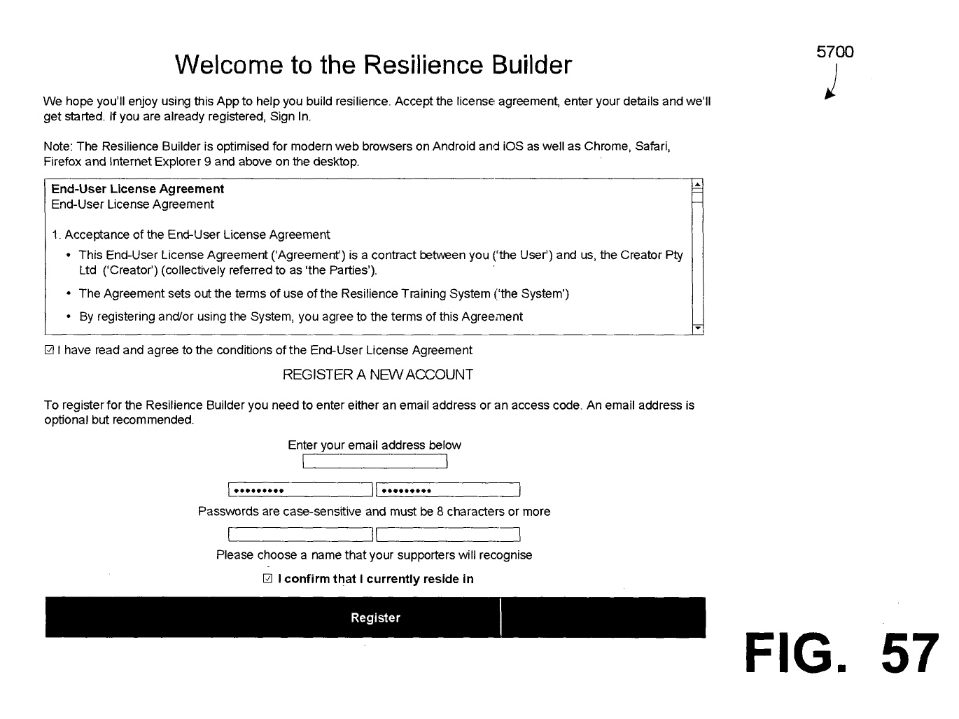

FIG. 57 is an example user registration screen 5700. Users can encounter a registration screen after following the instructions of the invitation.

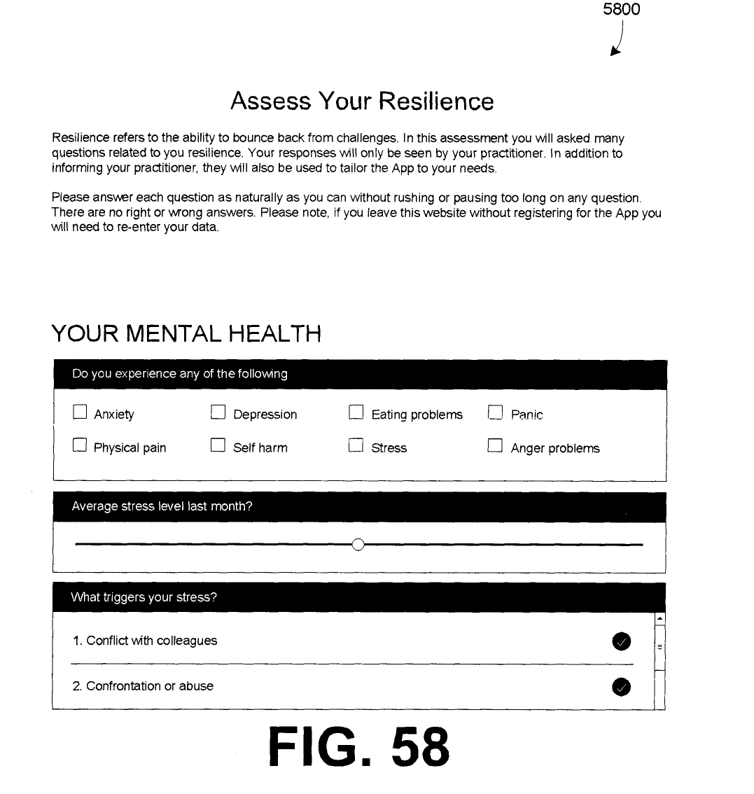

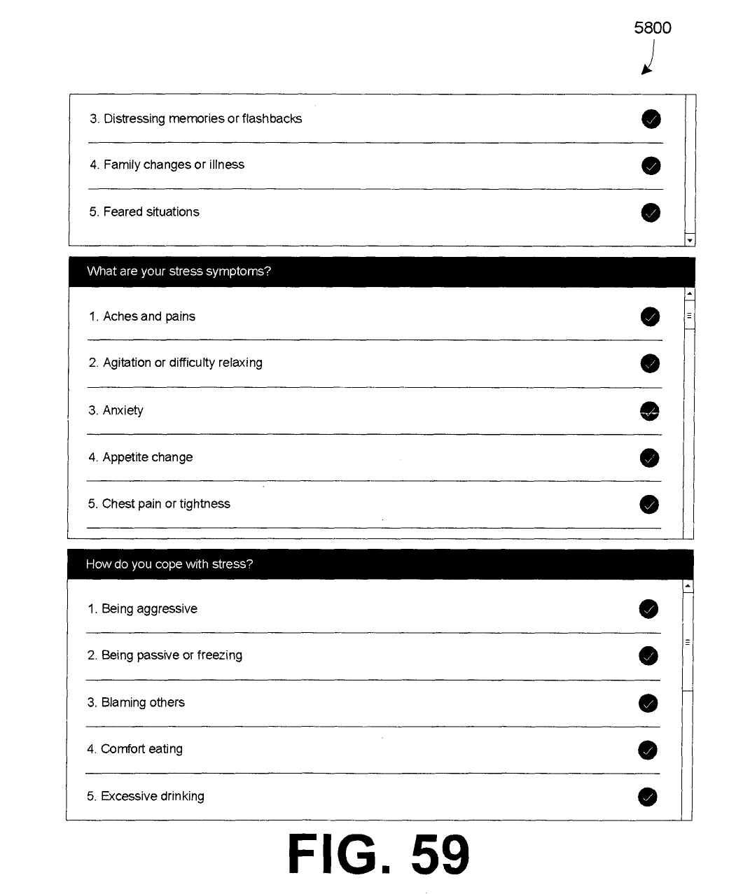

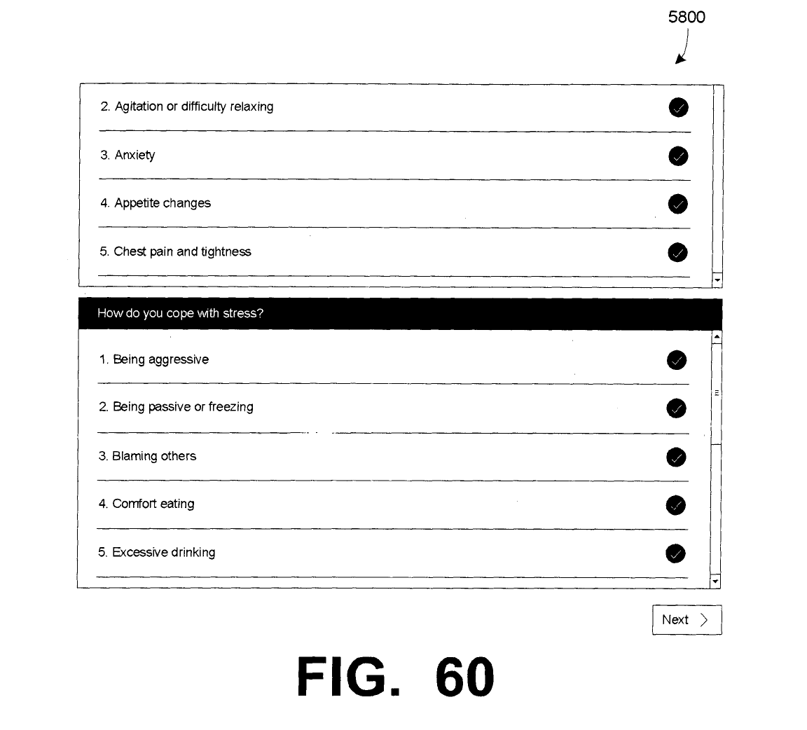

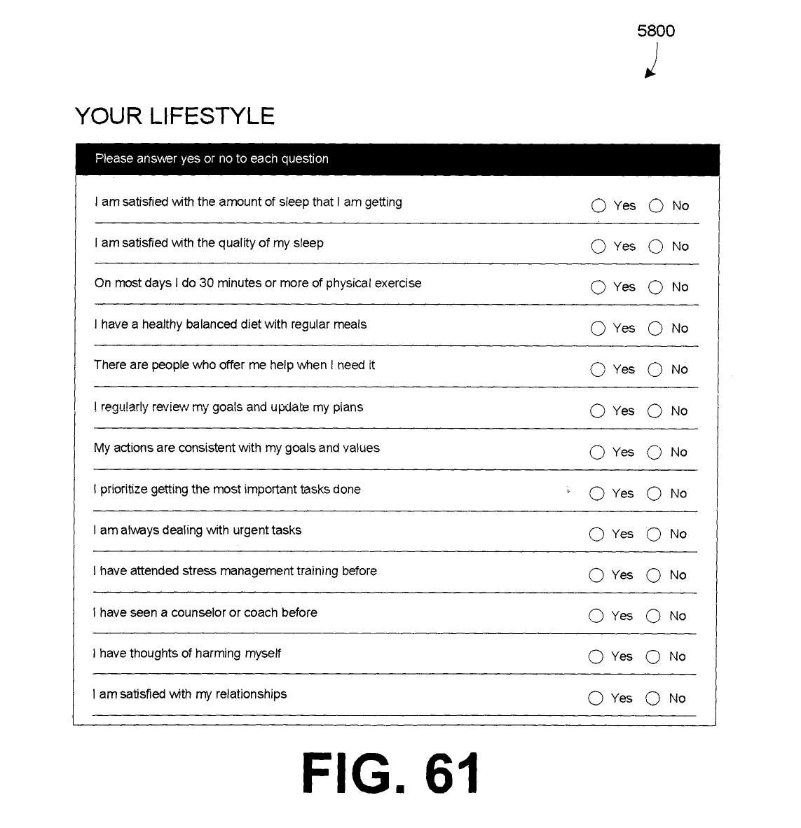

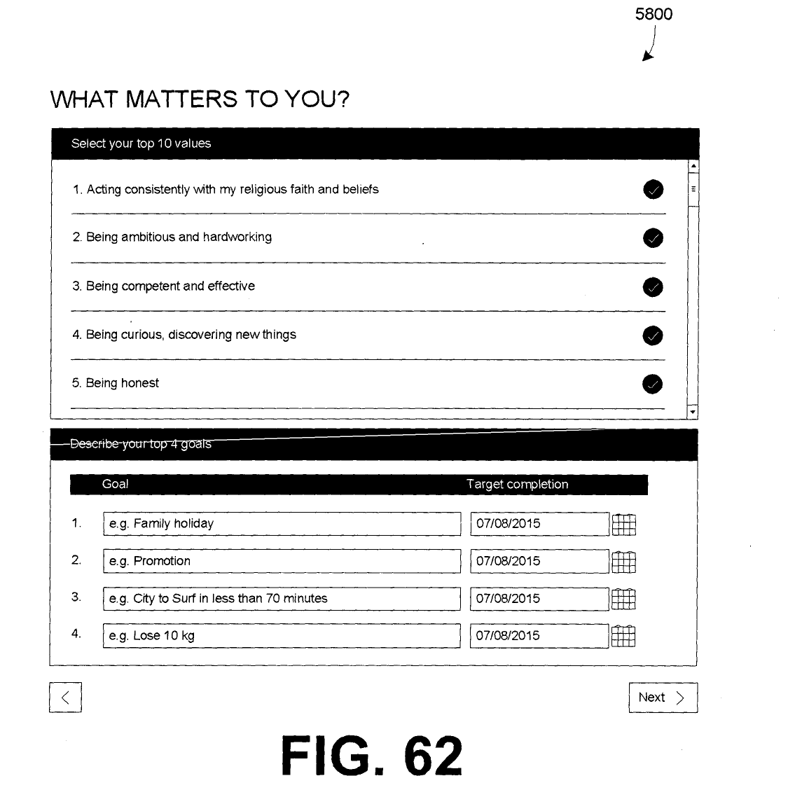

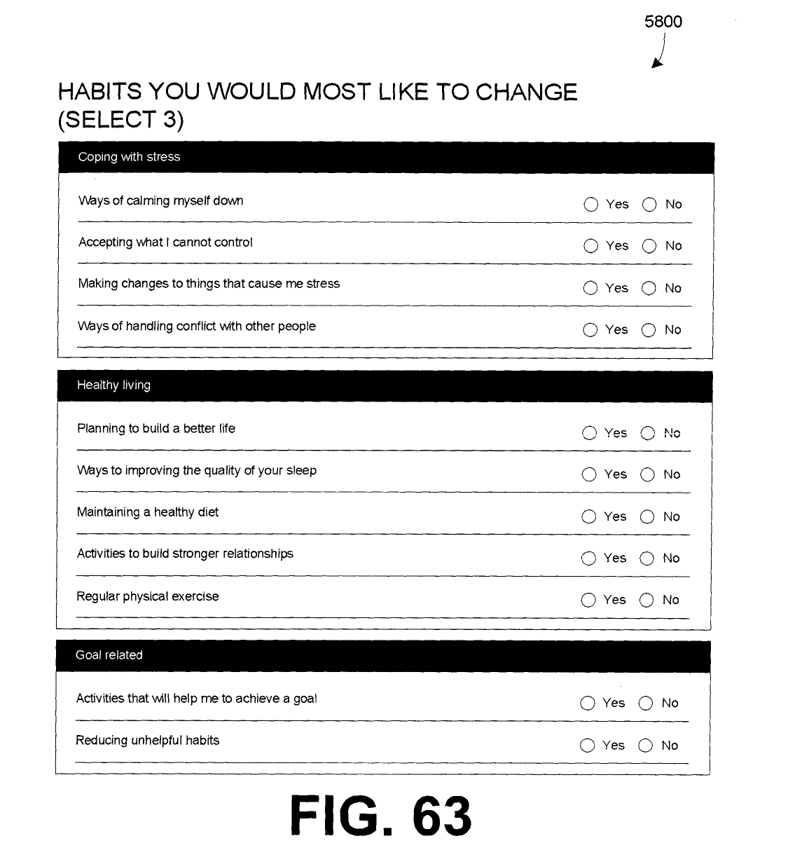

A user can be prompted to complete an initial assessment. FIGS. 58-63 illustrate an example assessment test 5800. This assessment can be used to pre-populate the behavior learning system profile of the user. Additionally, the assessment can be used for screening purposes to identify the appropriate level of support required for the user, whether the user is in group or individual training or therapy. For a group of users, the assessments of each user can be aggregated to determine an appropriate level of support for the group of users as a whole. The screening process of the assessment can also inform a practitioner of the support required for the user or users. Additionally, the screening process can identify factors that can be used in selecting the most appropriate practitioner for the user or users.

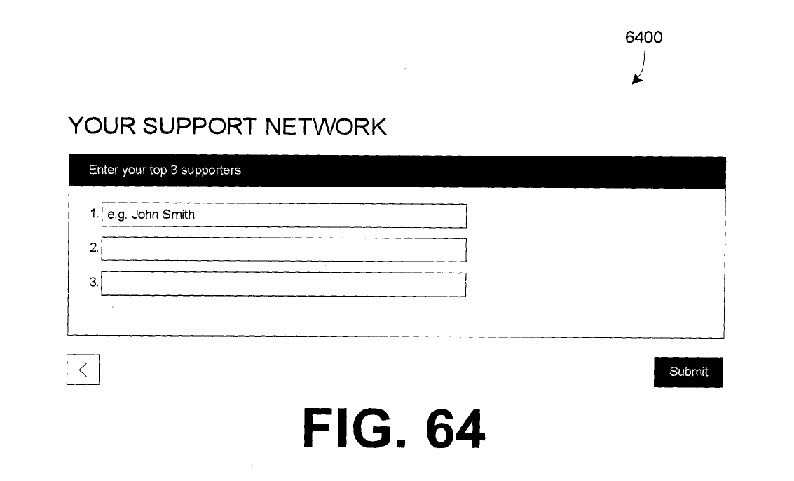

A user can add supporters to help them in their goals. FIG. 64 shows an example supporter input screen 6400, in which the user can add supporters as part of their registration process.

The above described system can be adapted to other therapy and coaching regimes, including training, reinforcement and assistance processes. Event factors can be added to the system that are targeted to these new therapy and coaching regimes. Such therapy and coaching regimes can include addiction therapy, sales training, life coaching and others.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing the invention in diverse forms thereof.

1. A method of behavior learning, comprising:
receiving input of at least one event factor value;
generating, in response to the received event factor value, at least one activity prescription value based at least in part on the at least one event factor value, the at least one activity prescription value based at least in part on a strength value; and
generating an output of one or more suggested activities based on at least one of the at least one of the event factor value, the at least one activity prescription value, and the strength value.

2. The method of claim 1, wherein the at least one activity prescription value provided in response to the received event factor value includes a plurality of activity prescription values.

3. The method of claim 1, further comprising:
receiving input of a plurality of event factor values;
in response to the received plurality of event factor values, providing a plurality of activity prescription values; and
generating an ordered suggested activities output based at least in part on the plurality of activity prescription values.

4. The method of claim 3, wherein the event factor values are weighted by at least one of a predetermined parameter, received goal input values, a received intensity value, and a received control value.

5. The method of claim 1, wherein the one or more suggested activities includes multiple suggested activities, the multiple suggested activities provided in an order over time.

6. The method of claim 1, wherein the event factor value is detected by a sensor and the suggested activity is provided as output in response to the detection of the event factor value by the sensor.

7. The method of claim 1, wherein at least one of the event factor values, the activity prescription values, and the suggested activities are customizable.

8. The method of claim 1, further comprising at least one of time stamping and location stamping the received event factors.

9. The method of claim 1, wherein the event factor values are selected from triggers, impacts, and behaviors.

10. The method of claim 1, further comprising receiving a goal value input, and wherein the generating the at least one activity prescription value is based on the event factor value and the goal value input.

11. The method of claim 1, wherein goal value input can be aligned with personal values in a plurality of domains.

12. A method of resilience training, comprising:
receiving an event factor value as input;
correlating to the event factor value to a suggested activity; and
generating an output that includes the suggested activity, wherein the suggested activity provides a habit value,
wherein the habit value is associated with a response field which when populated provides a tracking habit value.

13. The method of claim 12, the method further comprising:
receiving the tracking habit value as input;
correlating the tracking habit value to particular parameters; and
generating a progress value as output.

14. The method of claim 13, further comprising using the progress value to initiate social reinforcement.

15. The method of claim 12, further comprising;
processing the tracking input value with a plurality of tracking aggregated input values likewise received;
generating a success report value as output.

16. The method of claim 12, wherein the event factors values are customizable.

17. The method of claim 12, wherein the event factor values are representative of triggers, impacts, and behaviors.

18. The method of claim 12, wherein the event factor value inputs are received from an electronic detection element and the activity values are provided as output in response to the event factor values.

19. A method of e-learning comprising:
presenting content modules relating to event factor values representative of triggers, impacts, and behaviors;
correlating the content modules to a mobile application having attributes, wherein at least some of the attributes are demonstrated in the content modules; and
providing exercises within the modules based on the correlated content modules and mobile application having attributes, the exercises within the modules including information about the use of the mobile application.

20. The method of claim 19, further comprising providing a tracking system of the exercises, the tracking system configured to determine whether the exercises have been processed.

21. The method of claim 19, further comprising:
receiving an event factor value input via an e-learning application;
populating a back-end of a mobile application with the event factor value received via the e-learning application;
providing a suggested activity corresponding to the event factor value; and
transmitting suggested activity output that is based on the suggested activity, the suggested activity output configured to be transmitted to a mobile application operating on a mobile device.
